(19) United States
(12) Patent Application Publication
(10) Pub. No.: US 2026/0360816 A1
(43) Pub. Date: Nov. 12, 2026

(54) ELECTROLYTE, ELECTROCHEMICAL DEVICE USING SAME, AND ELECTRONIC DEVICE

(71) Applicant: Ningde Amperex Technology Limited, Ningde (CN)

(72) Inventors: Shan ZHANG, Ningde (CN); Hui CUI, Ningde (CN); Jianyu LIU, Ningde (CN); Chao TANG, Ningde (CN)

(73) Assignee: Ningde Amperex Technology Limited, Ningde (CN)

(21) Appl. No.: 19/631,104

(22) Filed: Mar. 27, 2026

Related U.S. Application Data
(63) Continuation of application No. PCT/CN2024/111677, filed on Aug. 13, 2024.

(30) Foreign Application Priority Data
Sep. 28, 2023 (CN) 202311277650.6

(51) Int. Cl. H01M 10/0567; H01G 11/06; H01G 11/60; H01M 10/0525; H01M 10/0569

(52) U.S. Cl. CPC H01M 10/0567; H01M 10/0525; H01M 10/0569; H01G 11/06; H01G 11/60; H01M 2300/0037

(57) ABSTRACT

An electrolyte comprises a first compound, a second compound, and a compound of formula (IV), where the first compound includes at least one of a compound of formula (I), a compound of formula (II), or a compound of formula (III), and the second compound includes at least one of the following compounds: ethylene carbonate, propylene carbonate, butylene carbonate, dimethyl carbonate, ethyl methyl carbonate, diethyl carbonate, dipropyl carbonate, methyl propyl carbonate, ethyl propyl carbonate, dioctyl carbonate, dipentyl carbonate, ethyl isobutyl carbonate, methyl isopropyl carbonate, dibutyl carbonate, diisopropyl carbonate, or propyl carbonate. Based on a mass of the electrolyte, a mass percentage of the first compound is 41.6% to 79%, a mass percentage of the second compound is 4.2% to 41.6%, and a mass percentage of the compound of formula (IV) is 4% to 15%.

### CROSS REFERENCE TO THE RELATED APPLICATIONS

This application is a continuation under 35 U.S.C. § 120 of international patent application PCT/CN2024/111677 filed on Aug. 13, 2024, which claims priority to the Chinese patent application filed with the China National Intellectual Property Administration on Sep. 28, 2023, with application number 202311277650.6 and entitled “ELECTROLYTE, ELECTROCHEMICAL DEVICE USING SAME, AND ELECTRONIC DEVICE”, which is incorporated herein by reference in its entirety.

### TECHNICAL FIELD

This application relates to the field of energy storage, specifically to an electrolyte, an electrochemical device using same, and an electronic device.

### BACKGROUND ART

Electrochemical devices (for example, lithium-ion batteries) have advantages such as high specific energy, light weight, and long cycle life, and are widely used in consumer electronics. With the trend toward thinner and more portable electronic products, there is an increasing demand for batteries with higher energy density, longer lifespan, and improved safety performance.

To further enhance the energy density of lithium-ion batteries, doping can be applied to the positive and negative electrodes. However, doping with higher-capacity materials generally leads to a deterioration in cycle life. To improve cycle life, elements such as Mn and Al can be doped into the positive electrode active material, but this doping results in capacity loss. Additionally, increasing the charge cut-off voltage can enhance lithium extraction from the material, thereby improving energy density. However, at high voltages, the positive and negative electrodes, separator, and electrolyte are prone to redox reactions, rendering them unstable and significantly degrading the cycle performance of the battery. Furthermore, to increase charging speed (that is, the transport rate of Li), the electrolyte typically requires high conductivity. Increasing the content of carboxylate esters can enhance electrolyte fluidity and conductivity, but these carboxylate esters are prone to side reactions at the positive and negative electrodes, leading to poor high-temperature cycle performance.

In view of this, there is a need to provide an effective strategy to improve the energy density, high-temperature cycle performance, and rate performance of electrochemical devices under high voltage.

### SUMMARY

This application provides an electrolyte, an electrochemical device using same, and an electronic device to attempt to address, at least to some extent, at least one issue existing in the related field.

According to one aspect of this application, an electrolyte is provided, including a first compound, a second compound, and a compound of formula (IV), where
the first compound includes at least one of a compound of formula (I), a compound of formula (II), or a compound of formula (III). The structural formulas of the compounds of formula (I), formula (II), formula (III), and formula (IV) are as follows:

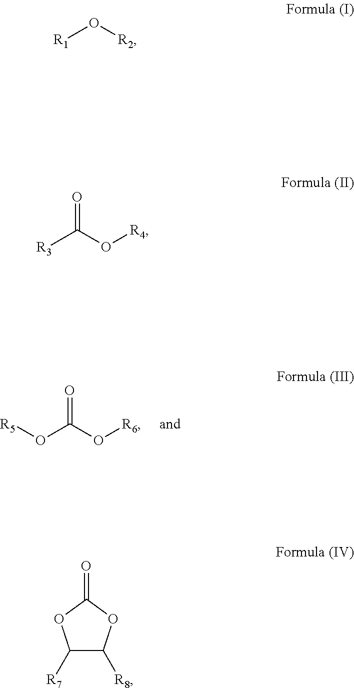

where R₁, R₂, R₃, R₄, R₅, R₆, R₇, and R₈ are each independently selected from H, F, C₁-C₅ alkyl, C₂-C₅ alkenyl, C₂-C₅ alkynyl, fluorine-substituted C₁-C₅ alkyl, fluorine-substituted C₂-C₅ alkenyl, fluorine-substituted C₂-C₅ alkynyl, sulfonic acid-substituted C₂-C₅ alkyl, or cyano-substituted C₂-C₅ alkyl; at least one of R₁ or R₂ contains at least one fluorine atom; at least one of R₃ or R₄ contains at least one fluorine atom; at least one of R₅ or R₆ contains at least one fluorine atom; and at least one of R₇ or R₈ contains at least one fluorine atom; the second compound includes at least one of the following compounds: ethylene carbonate, propylene carbonate, butylene carbonate, dimethyl carbonate, ethyl methyl carbonate, diethyl carbonate, dipropyl carbonate, methyl propyl carbonate, ethyl propyl carbonate, dioctyl carbonate, dipentyl carbonate, ethyl isobutyl carbonate, methyl isopropyl carbonate, dibutyl carbonate, diisopropyl carbonate, or propyl carbonate; and based on a mass of the electrolyte, a mass percentage of the first compound is A % and 41.6≤A≤79, a mass percentage of the second compound is B % and 4.2≤B≤41.6, and a mass percentage of the compound of formula (IV) is M % and 4≤M≤15. In this application, R₇ and R₈ may each independently represent one or more groups, where the groups may be selected from H, F, C₁-C₅ alkyl, C₂-C₅ alkenyl, C₂-C₅ alkynyl, fluorine-substituted C₁-C₅ alkyl, fluorine-substituted C₂-C₅ alkenyl, fluorine-substituted C₂-C₅ alkynyl, sulfonic acid-substituted C₂-C₅ alkyl, or cyano-substituted C₂-C₅ alkyl.

According to some embodiments of this application, the first compound includes at least one of the following compounds:

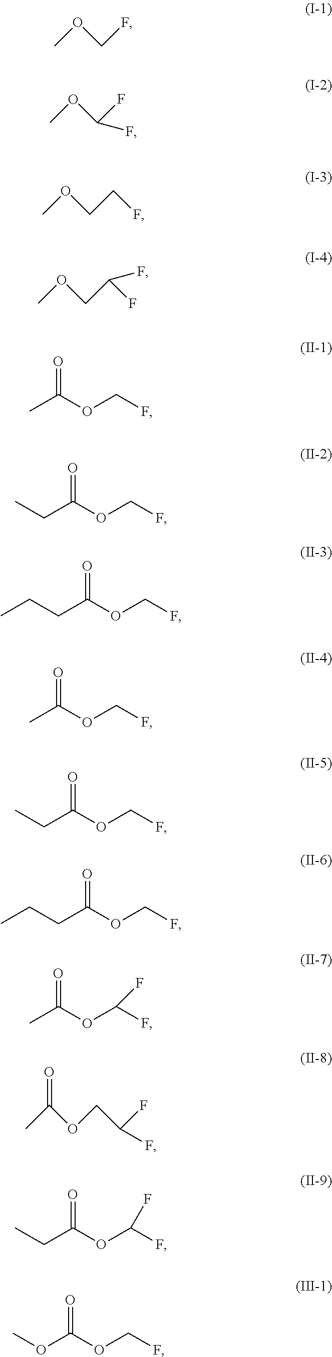

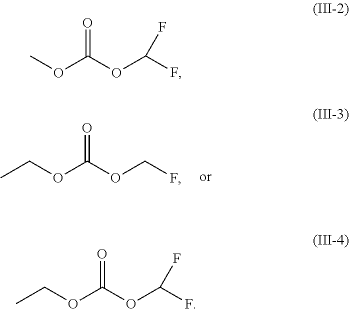

According to some embodiments of this application, the compound of formula (IV) includes at least one of the following compounds:

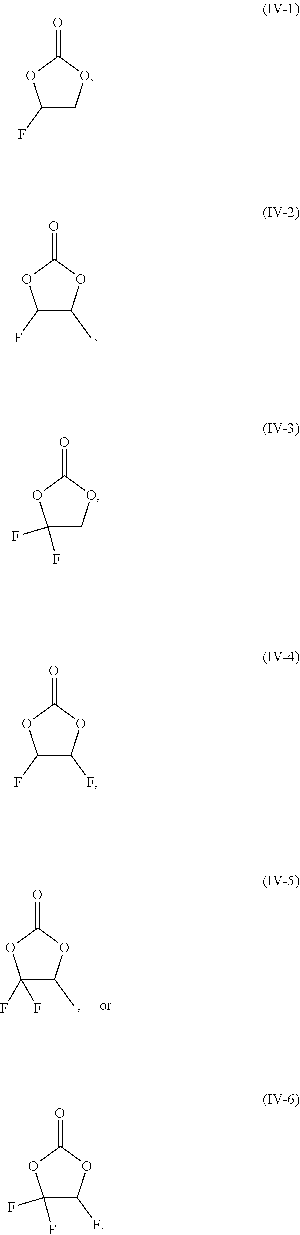

According to some embodiments of this application, 45.8≤A≤74.9 and 8.3≤B≤37.4.

According to some embodiments of this application, 49.9≤A≤74.9 and 8.3≤B≤33.3.

According to some embodiments of this application, the electrolyte further includes a nitrile compound, and based on the mass of the electrolyte, a mass percentage of the nitrile compound is C %, where 0<C≤7 and 0<100C/A≤12.0.

According to some embodiments of this application, the nitrile compound includes at least one of a compound having two cyano groups or a compound having three or more cyano groups, where the compound having two cyano groups includes at least one of the following compounds: malononitrile, succinonitrile, glutaronitrile, adiponitrile, suberonitrile, terephthalonitrile, tetradecanedinitrile, azopropanedinitrile, methyleneglutaronitrile, or pentenedinitrile; and the compound having three or more cyano groups includes at least one of the following compounds: nonanetrinitrile, 1,3,5-benzenetrinitrile, 2,4,6-trifluorobenzene-1,3,5-trinitrile, 2-bromobenzene-1,3,5-trinitrile, 1,3,6-hexanetrinitrile, propane-1,2,3-tricarbonitrile, pentane-1,3,5-tricarbonitrile, hexane-1,2,6-tricarbonitrile, or a compound of formula (V), where the

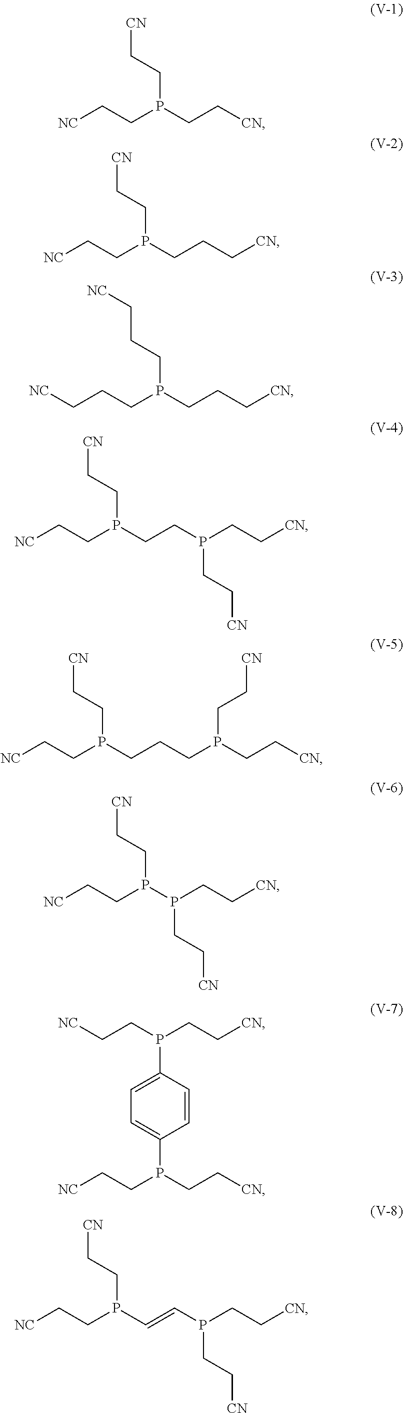

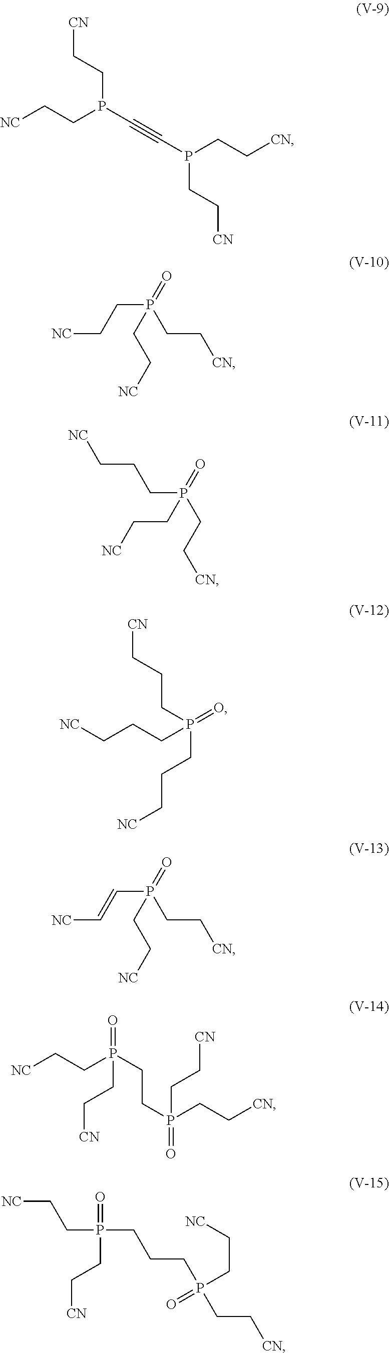

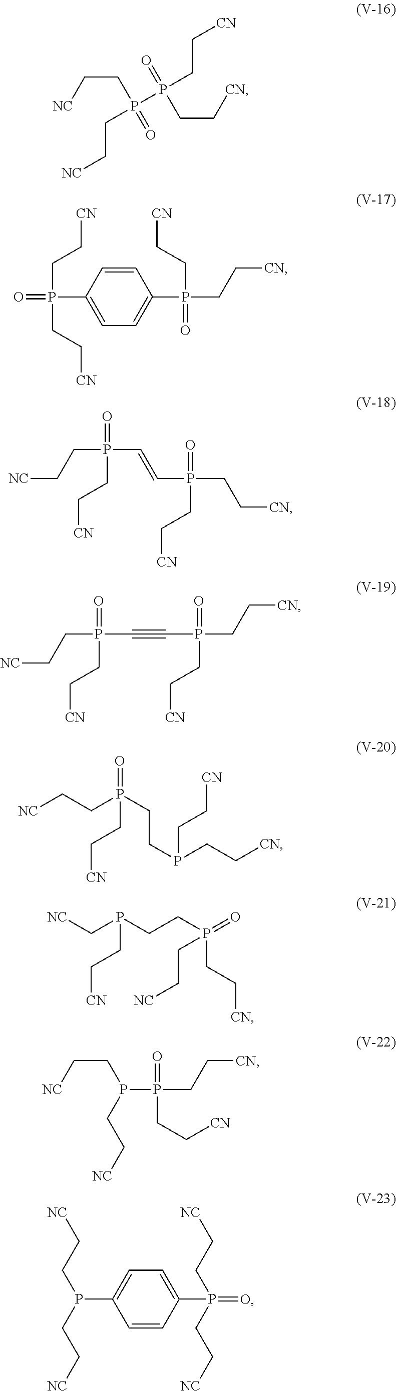

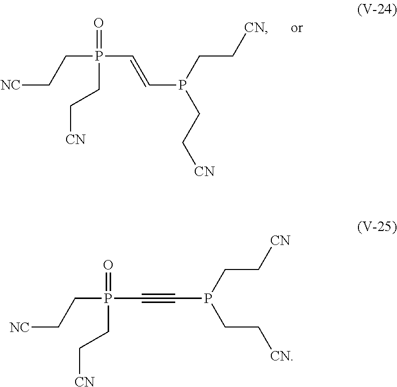 [SMILES: N#CCCP(/C=C/P(=O)(CCC#N)CCC#N)CCC#N ; N#CCCP(C#CP(=O)(CCC#N)CCC#N)CCC#N]

According to some embodiments of this application, the electrolyte further includes a compound of formula (VI):

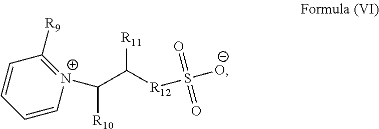

where R₉, R₁₀, and R₁₁ are each independently selected from H, F, substituted or unsubstituted C₁-C₅ alkyl, C₁-C₅ alkoxy, C₂-C₅ alkenyl, or C₂-C₅ alkynyl, where when any of these groups is substituted, the substituent is selected from at least one of F, formyl, or cyano; R₁₂ is selected from O or —CH(Rₐ)—; and Rₐ is selected from H, F, substituted or unsubstituted C₁-C₅ alkyl, or C₁-C₅ alkoxy, where when any of these groups is substituted, the substituent is selected from at least one of F, formyl, or cyano; and based on the mass of the electrolyte, a mass percentage of the compound of formula (VI) is D % and D is 0.01 to 3.

According to some embodiments of this application, the compound of formula (VI) includes at least one of the following compounds:

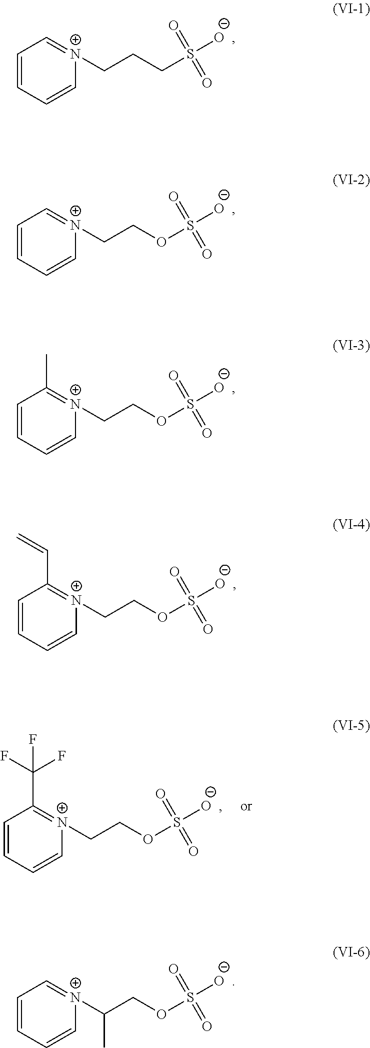 [SMILES: O=S(=O)([O-])CCC[n+]1ccccc1 ; O=S(=O)([O-])OCC[n+]1ccccc1 ; Cc1cccc[n+]1CCOS(=O)(=O)[O-] ; C=Cc1cccc[n+]1CCOS(=O)(=O)[O-] ; O=S(=O)([O-])OCC[n+]1ccccc1C(F)(F)F ; CC(COS(=O)(=O)[O-])[n+]1ccccc1]

According to some embodiments of this application, the electrolyte further includes a first additive, the first additive including at least one of 1,3-propane sultone, ethylene sulfate, or vinylene carbonate, and based on the mass of the electrolyte, a mass percentage of the first additive is less than or equal to 5%.

According to some embodiments of this application, the electrolyte further includes a third compound, the third compound including at least one of methyl acetate, ethyl acetate, propyl acetate, methyl propionate, ethyl propionate, propyl propionate, butyl propionate, methyl butyrate, ethyl butyrate, propyl butyrate, or butyl butyrate, and based on the mass of the electrolyte, a mass percentage of the third compound is less than or equal to 20%.

According to another aspect of this application, an electrochemical device is provided, including a positive electrode, a negative electrode, a separator, and the electrolyte described in this application.

According to yet another aspect of this application, an electronic device is provided, including the electrochemical device described in this application.

By using an electrolyte containing specific contents and types of the first compound, the second compound, and the compound of formula (IV), this application can significantly improve the energy density, high-temperature cycle performance, and rate performance of electrochemical devices under high voltage.

Additional aspects and advantages of this application will be partially described, illustrated, or explained through the implementation of the embodiments of this application.

### DETAILED DESCRIPTION

The embodiments of this application will be described in detail below. The embodiments of this application should not be construed as limiting the application.

In the detailed description and claims, a list of items connected by the term “at least one of” may mean any combination of the listed items. For example, if items A and B are listed, the phrase “at least one of A and B” means only A; only B; or A and B. In another example, if items A, B, and C are listed, the phrase “at least one of A, B, and C” means only A; only B; only C; A and B (excluding C); A and C (excluding B); B and C (excluding A); or all of A, B, and C. Item A may include a single element or multiple elements. Item B may include a single element or multiple elements. Item C may include a single element or multiple elements.

As used herein, the term “alkyl” is intended to mean a straight-chain saturated hydrocarbon structure having 1 to 20 carbon atoms. The term “alkyl” also is intended to mean a branched or cyclic hydrocarbon structure having 3 to 20 carbon atoms. When an alkyl group with a specific number of carbon atoms is specified, it is intended to encompass all geometric isomers with that number of carbon atoms; thus, for example, “butyl” includes n-butyl, sec-butyl, isobutyl, tert-butyl, and cyclobutyl; “propyl” includes n-propyl, isopropyl, and cyclopropyl. Examples of alkyl groups include, but are not limited to, methyl, ethyl, n-propyl, isopropyl, cyclopropyl, n-butyl, isobutyl, sec-butyl, tert-butyl, cyclobutyl, n-pentyl, isopentyl, neopentyl, cyclopentyl, methylcyclopentyl, ethylcyclopentyl, n-hexyl, isohexyl, cyclohexyl, n-heptyl, octyl, cyclopropyl, cyclobutyl, norbornyl, and the like.

As used herein, the term “alkenyl” refers to a monovalent unsaturated hydrocarbon group that may be straight-chain or branched and has at least one, and typically 1, 2, or 3, carbon-carbon double bonds. Unless otherwise defined, the alkenyl group typically contains 2 to 20 carbon atoms and includes, for example, —C₂₋₄ alkenyl, —C₂₋₆ alkenyl, and —C₂₋₁₀ alkenyl. Representative alkenyl groups include, for example, vinyl, n-propenyl, isopropenyl, n-but-2-enyl, but-3-enyl, n-hex-3-enyl, and the like.

As used herein, the term “alkynyl” refers to a monovalent unsaturated hydrocarbon group that may be straight-chain or branched and has at least one, and typically 1, 2, or 3, carbon-carbon triple bonds. Unless otherwise defined, the alkynyl group typically contains 2 to 20 carbon atoms and includes, for example, —C₂₋₄ alkynyl, —C₃₋₆ alkynyl, and —C₃₋₁₀ alkynyl. Representative alkynyl groups include, for example, ethynyl, prop-2-ynyl (n-propynyl), n-but-2-ynyl, n-hex-3-ynyl, and the like.

As used herein, the term “alkoxy” refers to an alkyl group attached to the parent structure via an oxygen atom (—O-alkyl). When a cycloalkyl group is attached to the parent structure via an oxygen atom, the group may also be referred to as cycloalkoxy. Examples include methoxy, ethoxy, propoxy, isopropoxy, cyclopropoxy, butoxy, sec-butoxy, tert-butoxy, pentoxy, cyclohexyloxy, and the like. The term “perhaloalkoxy” is intended to mean a perhaloalkyl group attached to the parent structure via an oxygen atom, such as the group —O—CF₃.

Electrochemical devices (for example, lithium-ion batteries) have been widely used in various fields due to their superior performance, and the requirements for their performance, such as energy density, cycle performance, and rate performance, are increasing. The energy density of electrochemical devices can typically be improved by doping the positive and negative electrodes, for example, by doping Ni into the positive electrode active material LiCoO₂. However, doping the positive and negative electrodes often deteriorates the cycle performance of electrochemical devices, particularly at high temperatures. Further doping elements such as Mn or Al into the positive electrode active material LiCoO₂ can improve the cycle life of electrochemical devices, but these elements lead to capacity loss. Additionally, increasing the charge cut-off voltage can enhance lithium extraction from the material, thereby improving energy density. However, at high voltages, the positive and negative electrodes, separator, and electrolyte are prone to redox reactions, rendering them unstable and significantly degrading the cycle life of electrochemical devices. Furthermore, increasing the content of carboxylate esters can enhance electrolyte fluidity and conductivity, thereby improving charging speed (that is, the transport rate of Li). However, carboxylate esters are prone to reactions at the positive and negative electrodes, leading to poor high-temperature cycle performance.

To address the above issues, this application provides an electrolyte including a first compound, a second compound, and a compound of formula (IV), where: the first compound includes at least one of a compound of formula (I), a compound of formula (II), or a compound of formula (III). The structural formulas of the compounds of formula (I), formula (II), formula (III), and formula (IV) are as follows:

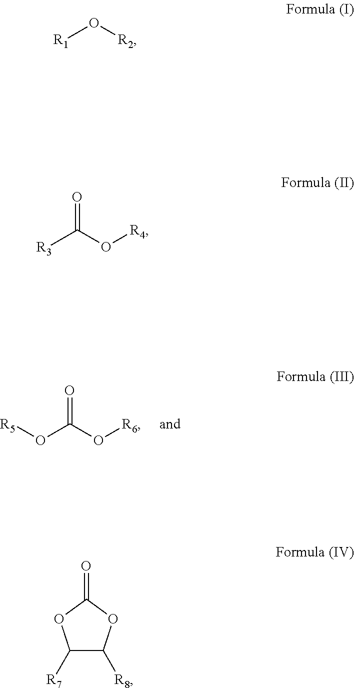

where R₁, R₂, R₃, R₄, R₅, R₆, R₇, and R₈ are each independently selected from H, F, C₁-C₅ alkyl, C₂-C₅ alkenyl, C₂-C₅ alkynyl, fluorine-substituted C₁-C₅ alkyl, fluorine-substituted C₂-C₅ alkenyl, fluorine-substituted C₂-C₅ alkynyl, sulfonic acid-substituted C₂-C₅ alkyl, or cyano-substituted C₂-C₅ alkyl; at least one of R₁ or R₂ contains at least one fluorine atom; at least one of R₃ or R₄ contains at least one fluorine atom; at least one of R₅ or R₆ contains at least one fluorine atom; and at least one of R₇ or R₈ contains at least one fluorine atom; the second compound includes at least one of the following compounds: ethylene carbonate, propylene carbonate, butylene carbonate, dimethyl carbonate, ethyl methyl carbonate, diethyl carbonate, dipropyl carbonate, methyl propyl carbonate, ethyl propyl carbonate, dioctyl carbonate, dipentyl carbonate, ethyl isobutyl carbonate, methyl isopropyl carbonate, dibutyl carbonate, diisopropyl carbonate, or propyl carbonate; and
based on a mass of the electrolyte, a mass percentage of the first compound is A % and 41.6≤A≤79, a mass percentage of the second compound is B % and 4.2≤B≤41.6, and a mass percentage of the compound of formula (IV) is M % and 4≤M≤15.

When the first compound is added to the electrolyte, the electrochemical device can achieve better cycle performance. Additionally, since excessive additives are not required to continuously repair the interface, the consumption of active lithium at the interface is reduced, thereby improving the energy density of the electrochemical device. Furthermore, adding the second compound to the electrolyte can increase the dissociation of lithium salts, thereby improving the rate performance of the electrochemical device, significantly reducing charging time, and further enhancing the high-temperature cycle performance of the electrochemical device. Adding the compound of formula (IV) to the electrolyte enables preferential reduction at the negative electrode to form a passivation layer, reducing the consumption of active lithium at the negative electrode. However, it tends to approach the negative electrode surface, undergoing dehydrogenation reactions at the negative electrode to form HF, which continuously erodes the positive electrode interface. When the contents of the first compound, the second compound, and the compound of formula (IV) in the electrolyte satisfy specific ranges, the first compound reacts preferentially, resulting in an interface component containing a high amount of LiF, which provides high mechanical strength and corrosion resistance. Therefore, the electrochemical device maintains excellent high-temperature cycle performance under high voltage. Meanwhile, the presence of the second compound prevents a significant increase in charging time due to insufficient lithium salt dissociation, thereby improving the rate performance of the electrochemical device. Adding the first compound, the second compound, and the compound of formula (IV) in the above contents to the electrolyte enables continuous interface repair, significantly improving the energy density, high-temperature cycle performance, and rate performance of the electrochemical device under high voltage, thereby enhancing the overall performance of the electrochemical device.

In some embodiments, 45.8≤A≤74.9. In some embodiments, 49.9≤A≤74.9. In some embodiments, A is 45.8, 49.9, 55, 60, 65, 70, 74.9, or any value within the range formed by any two of these values. When the content of the first compound in the electrolyte is within the above range, the energy density, high-temperature cycle performance, and rate performance of the electrochemical device under high voltage can be further improved, thereby enhancing the overall performance of the electrochemical device.

In some embodiments, 8.3≤B≤37.4. In some embodiments, 8.3≤B≤33.3. In some embodiments, B is 8.3, 10, 12, 15, 18, 20, 25, 30, 33.3, 37.4, or any value within the range formed by any two of these values. When the content of the second compound in the electrolyte is within the above range, the energy density, high-temperature cycle performance, and rate performance of the electrochemical device under high voltage can be further improved, thereby enhancing the overall performance of the electrochemical device.

In some embodiments, the first compound includes at least one of the following compounds:

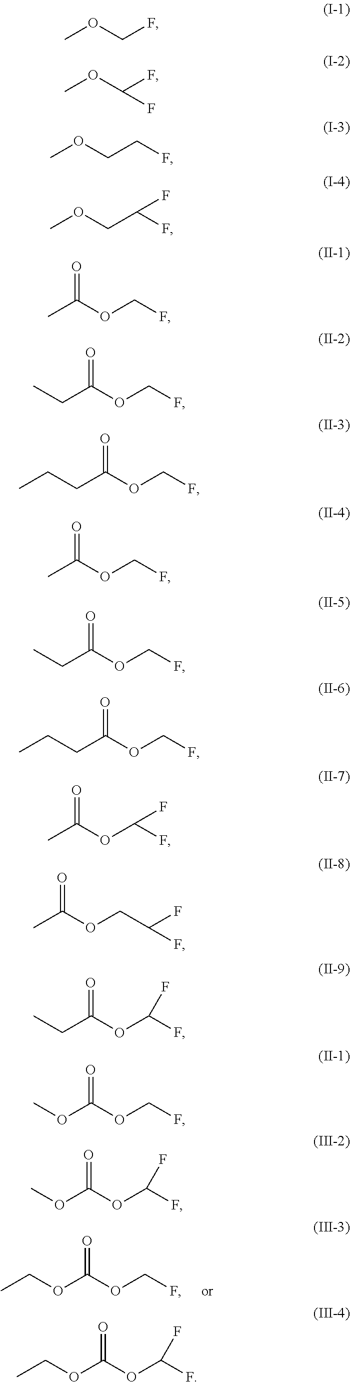

In some embodiments, the compound of formula (IV) includes at least one of the following compounds:

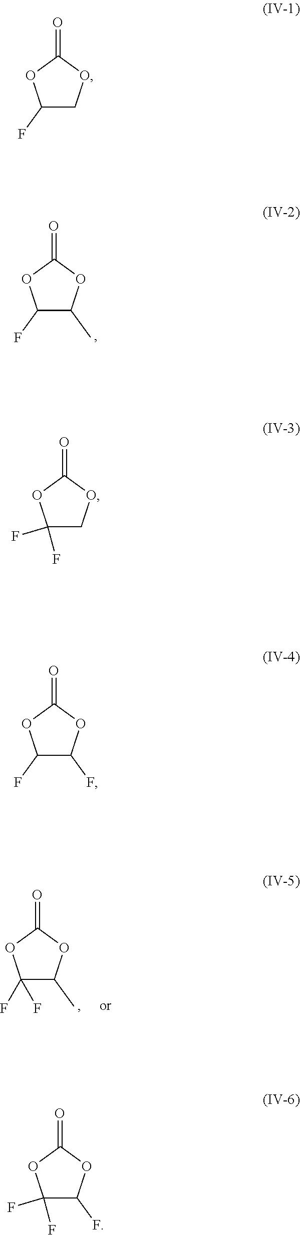

In some embodiments, the electrolyte further includes a nitrile compound.

In some embodiments, the nitrile compound includes at least one of a compound having two cyano groups or a compound having three or more cyano groups. A compound having two cyano groups may be abbreviated as a dinitrile, a compound having three cyano groups may be abbreviated as a trinitrile, and a compound having more cyano groups may be abbreviated as a polynitrile.

In some embodiments, the compound having two cyano groups includes at least one of the following compounds: malononitrile, succinonitrile, glutaronitrile, adiponitrile, suberonitrile, terephthalonitrile, tetradecanedinitrile, azopropanedinitrile, methyleneglutaronitrile, or pentenedinitrile.

In some embodiments, the compound having three or more cyano groups includes at least one of the following compounds: nonanetrinitrile, 1,3,5-benzenetrinitrile, 2,4,6-trifluorobenzene-1,3,5-trinitrile, 2-bromobenzene-1,3,5-trinitrile, 1,3,6-hexanetrinitrile, propane-1,2,3-tricarbonitrile, pentane-1,3,5-tricarbonitrile, hexane-1,2,6-tricarbonitrile, or a compound of formula (V), where the

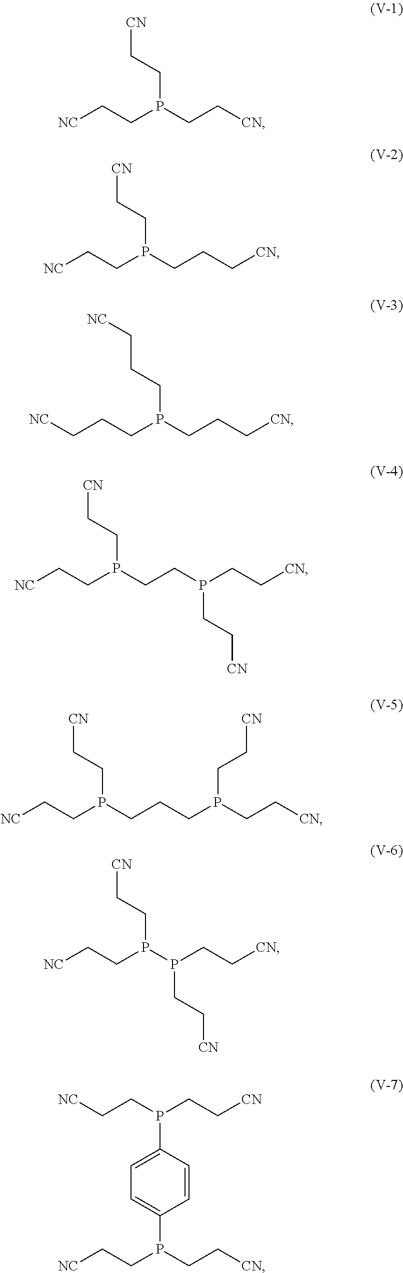

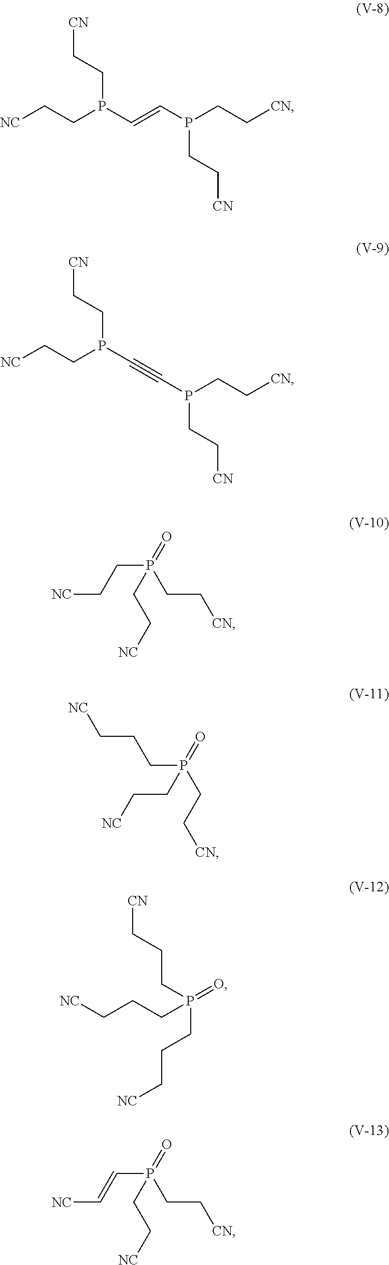 [SMILES: N#CCCP(/C=C/P(CCC#N)CCC#N)CCC#N ; N#CCCP(C#CP(CCC#N)CCC#N)CCC#N ; N#CCCP(=O)(CCC#N)CCC#N ; N#CCCCP(=O)(CCC#N)CCC#N ; N#CCCCP(=O)(CCCC#N)CCCC#N ; N#C/C=C/P(=O)(CCC#N)CCC#N]

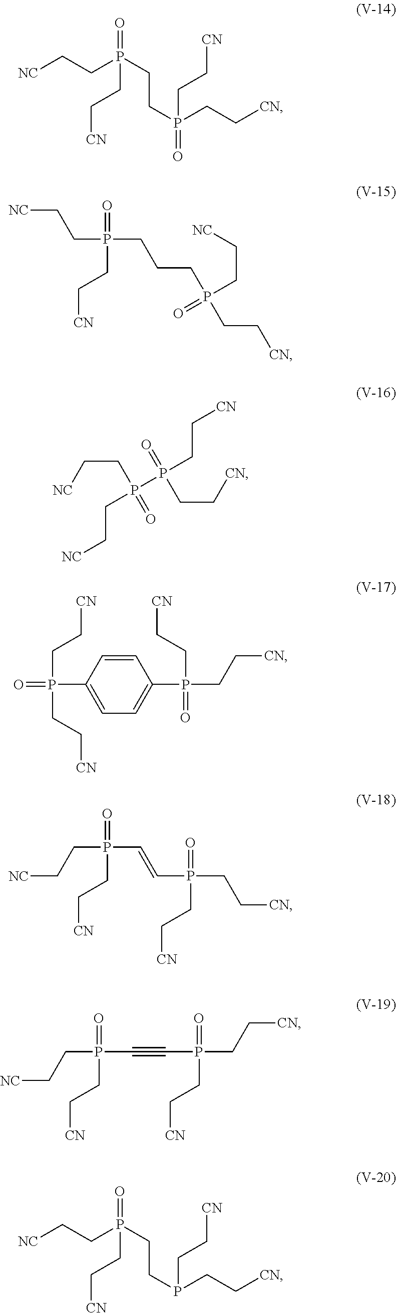

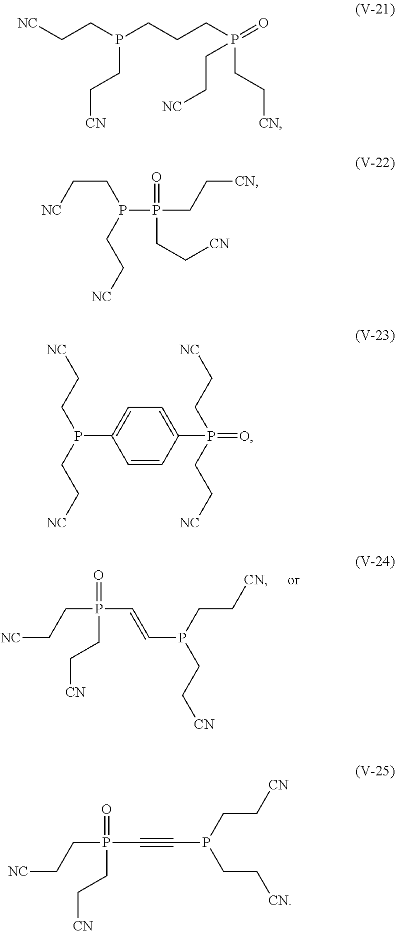 [SMILES: N#CCCP(CCC#N)CCCP(=O)(CCC#N)CCC#N ; N#CCCP(CCC#N)P(=O)(CCC#N)CCC#N ; N#CCCP(CCC#N)c1ccc(P(=O)(CCC#N)CCC#N)cc1 ; N#CCCP(/C=C/P(=O)(CCC#N)CCC#N)CCC#N ; N#CCCP(C#CP(=O)(CCC#N)CCC#N)CCC#N]

In some embodiments, based on the mass of the electrolyte, a mass percentage of the nitrile compound is C %, where 0<C≤7 and 0<100C/A≤12.0. In some embodiments, C is 0.5, 1, 2, 3, 4, 5, 6, 7, or any value within the range formed by any two of these values. In some embodiments, 100C/A is 0.5, 1, 3, 5, 8, 10, 12.0, or any value within the range formed by any two of these values.

The nitrile compound can bind with transition metals on the positive electrode surface, and together with the first compound, the nitrile compound forms a coating layer of inorganic or organic compounds containing F and cyano groups. This coating layer has the antioxidant properties of the first compound, reducing side reactions in the electrolyte, and the strong chelating effect of the nitrile compound on transition metals, making the structure of the positive electrode material more stable, thereby further improving the cycle performance and high-temperature storage performance of the electrochemical device under high temperature and high voltage.

In some embodiments, the electrolyte further includes a compound of formula (VI):

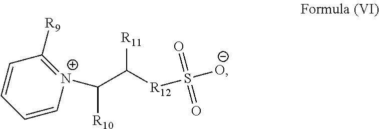

where R₉, R₁₀, and R₁₁ are each independently selected from H, F, substituted or unsubstituted C₁-C₅ alkyl, C₁-C₅ alkoxy, C₂-C₅ alkenyl, or C₂-C₅ alkynyl, where when any of these groups is substituted, the substituent is selected from at least one of F, formyl, or cyano; R₁₂ is selected from O or —CH(Rₐ)—; and Rₐ is selected from H, F, substituted or unsubstituted C₁-C₅ alkyl, or C₁-C₅ alkoxy, where when any of these groups is substituted, the substituent is selected from at least one of F, formyl, or cyano.

In some embodiments, the compound of formula (VI) includes at least one of the following compounds:

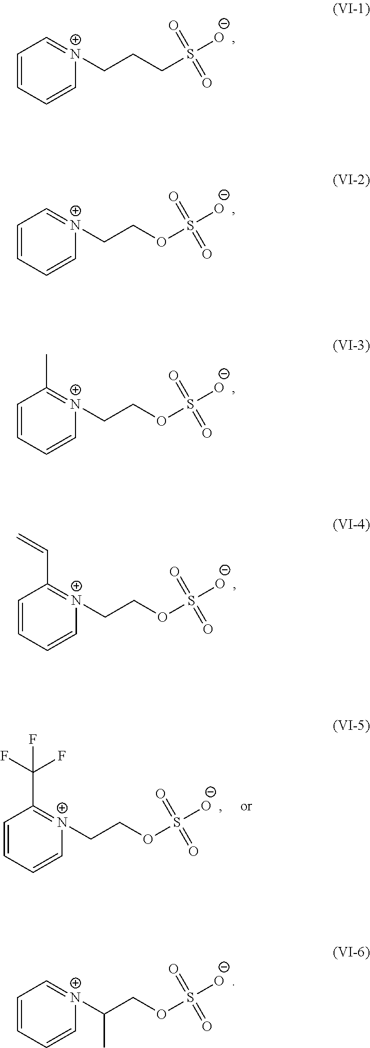 [SMILES: O=S(=O)([O-])CCC[n+]1ccccc1 ; O=S(=O)([O-])OCC[n+]1ccccc1 ; Cc1cccc[n+]1CCOS(=O)(=O)[O-] ; C=Cc1cccc[n+]1CCOS(=O)(=O)[O-] ; O=S(=O)([O-])OCC[n+]1ccccc1C(F)(F)F ; CC(COS(=O)(=O)[O-])[n+]1ccccc1]

In some embodiments, based on the mass of the electrolyte, a mass percentage of the compound of formula (VI) is D % and D is 0.01 to 3. In some embodiments, D is 0.01, 0.05, 0.1, 0.5, 1, 1.5, 2, 2.5, 3, or any value within the range formed by any two of these values.

The compound of formula (VI) readily reacts with the nitrile compound at the negative electrode, effectively mitigating the impact of the first compound and the nitrile compound on the negative electrode, significantly improving the stability of the negative electrode interface, thereby significantly enhancing the cycle performance of the electrochemical device under high temperature and high voltage and improving its thermal stability, such as hot-box performance.

In some embodiments, the electrolyte further includes a first additive, the first additive including at least one of 1,3-propane sultone (PS), ethylene sulfate (DTD), or vinylene carbonate (VC).

In some embodiments, based on the mass of the electrolyte, the mass percentage of the first additive is less than or equal to 5%. In some embodiments, based on the mass of the electrolyte, the mass percentage of the first additive is 0.1%, 0.3%, 0.5%, 0.8%, 1%, 3%, 5%, or any value within the range formed by any two of these values.

When the electrolyte contains a certain amount of the first additive, the cycle performance of the electrochemical device under high temperature and high voltage can be further improved.

In some embodiments, the electrolyte further includes a second additive, the second additive including at least one of lithium tetrafluoroborate, lithium bis(oxalato)borate, lithium difluoro(oxalato)borate, or lithium difluorophosphate.

In some embodiments, based on the mass of the electrolyte, the mass percentage of the second additive is less than or equal to 5%. In some embodiments, based on the mass of the electrolyte, the mass percentage of the second additive is 1%, 2%, 3%, 4%, 5%, or any value within the range formed by any two of these values.

When the electrolyte contains a certain amount of the second additive, the interface film formed by the second additive has superior stability, thereby improving the cycle performance of the electrochemical device under high temperature and high voltage.

In some embodiments, the electrolyte further includes a third compound, the third compound including at least one of methyl acetate, ethyl acetate, propyl acetate, methyl propionate, ethyl propionate, propyl propionate, butyl propionate, methyl butyrate, ethyl butyrate, propyl butyrate, or butyl butyrate.

In some embodiments, based on the mass of the electrolyte, a mass percentage of the third compound is less than or equal to 20%. In some embodiments, based on the mass of the electrolyte, the mass percentage of the third compound is 1%, 5%, 10%, 15%, 20%, or any value within the range formed by any two of these values.

Adding the third compound to the electrolyte helps reduce the viscosity of the electrolyte, facilitating faster lithium-ion transport. When the electrolyte contains the third compound in the above content, it contributes to further improving the cycle performance of the electrochemical device under high temperature and high voltage.

In some embodiments, the electrolyte further includes a lithium salt, the lithium salt including at least one of LiPF₆, LiTFSI, LiFSI, LiAsF₆, LiClO₄, LiB(C₆H₅)₄, LiCH₃SO₃, LiCF₃SO₃, LiN(SO₂CF₃)₂, LiC(SO₂CF₃)₃, or Li₂SiF₆.

In some embodiments, based on the mass of the electrolyte, a mass percentage of the lithium salt is 8% to 20%. In some embodiments, based on the mass of the electrolyte, the mass percentage of the lithium salt is 8%, 10%, 12%, 15%, 18%, 20%, or any value within the range formed by any two of these values. When the content of the lithium salt in the electrolyte is within the above range, the overall performance of the electrochemical device can be further improved.

This application also provides an electrochemical device including a positive electrode, a negative electrode, a separator, and the electrolyte described in this application.

In some embodiments, the positive electrode includes a positive electrode current collector and a positive electrode material layer disposed on at least one surface of the positive electrode current collector, the positive electrode material layer including a positive electrode active material. In this application, the term “positive electrode material layer disposed on at least one surface of the positive electrode current collector” means that the positive electrode material layer may be disposed on one surface of the positive electrode current collector along its thickness direction or on both surfaces of the positive electrode current collector along its thickness direction. It should be noted that the term “surface” here may refer to the entire area of the positive electrode current collector surface or a partial area of the positive electrode current collector surface, and this application imposes no specific limitation, as long as the purpose of this application can be achieved. This application imposes no specific limitation on the positive electrode current collector, as long as the purpose of this application can be achieved. For example, it may include aluminum foil, aluminum alloy foil, or a composite current collector (for example, an aluminum-carbon composite current collector).

In some embodiments, the positive electrode material layer may further include a conductive agent and a binder. This application imposes no specific limitation on the types of conductive agent and binder, as long as the purpose of this application can be achieved. For example, the conductive agent may include, but is not limited to, at least one of conductive carbon black (Super P), carbon nanotubes (CNTs), carbon fibers, flake graphite, Ketjen black, graphene, metal materials, or conductive polymers. The carbon nanotubes may include, but are not limited to, single-walled carbon nanotubes and/or multi-walled carbon nanotubes. The carbon fibers may include, but are not limited to, vapor-grown carbon fibers (VGCF) and/or carbon nanofibers. The metal materials may include, but are not limited to, metal powders and/or metal fibers, specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole. For example, the binder may include, but is not limited to, at least one of polyacrylic acid, sodium polyacrylate, potassium polyacrylate, lithium polyacrylate, polyimide, polyvinyl alcohol, carboxymethyl cellulose, sodium carboxymethyl cellulose, lithium carboxymethyl cellulose, polyimide, polyamide-imide, styrene-butadiene rubber, or polyvinylidene fluoride. This application imposes no specific limitation on the mass ratio of the positive electrode active material, conductive agent, and binder in the positive electrode material layer, and those skilled in the art may select according to actual needs, as long as the purpose of this application can be achieved.

This application imposes no specific limitation on the thicknesses of the positive electrode current collector and the positive electrode material layer, as long as the purpose of this application can be achieved. For example, the thickness of the positive electrode current collector may be 6 μm to 15 μm, and the thickness of the positive electrode material layer may be 30 μm to 120 μm. This application imposes no specific limitation on the thickness of the positive electrode plate, as long as the purpose of this application can be achieved. For example, the thickness of the positive electrode plate may be 50 μm to 250 μm.

This application imposes no specific limitation on the preparation method of the positive electrode active material, as long as the purpose of this application can be achieved. For example, the preparation method of the positive electrode active material may include, but is not limited to, the following steps: uniformly mixing LiCoO₂ (CAS number: 12190-79-3) with a nickel-containing compound, followed by heat treatment in an air atmosphere to obtain the positive electrode active material. This application imposes no specific limitation on the temperature, time, and heating rate of the heat treatment, as long as the purpose of this application can be achieved. For example, the heat treatment temperature may be 650 °C to 850 °C, the time may be 22 hours to 26 hours, and the heating rate may be 2 °C/min to 8 °C/min. This application imposes no specific limitation on the mass ratio of LiCoO₂ to the nickel-containing compound, as long as the purpose of this application can be achieved.

In some embodiments, the negative electrode plate may include a negative electrode current collector and a negative electrode material layer disposed on at least one surface of the negative electrode current collector. In this application, the term “negative electrode material layer disposed on at least one surface of the negative electrode current collector” means that the negative electrode material layer may be disposed on one surface of the negative electrode current collector along its thickness direction or on both surfaces of the negative electrode current collector along its thickness direction. It should be noted that the term “surface” here may refer to the entire area of the negative electrode current collector surface or a partial area of the negative electrode current collector surface, and this application imposes no specific limitation, as long as the purpose of this application can be achieved.

This application imposes no specific limitation on the negative electrode current collector, as long as the purpose of this application can be achieved. For example, it may include copper foil, copper alloy foil, nickel foil, stainless steel foil, titanium foil, nickel foam, copper foam, or a composite current collector (for example, lithium-copper composite current collector, carbon-copper composite current collector, nickel-copper composite current collector, titanium-copper composite current collector, and the like). The negative electrode current collector may be a metal plate without through-holes or a porous metal plate with through-holes.

In some embodiments, the negative electrode material layer includes a negative electrode active material. This application imposes no specific limitation on the negative electrode active material, as long as the purpose of this application can be achieved. For example, the negative electrode active material may include, but is not limited to, at least one of natural graphite, artificial graphite, mesocarbon microbeads, hard carbon, soft carbon, silicon, silicon-carbon composite, Li—Sn alloy, Li—Sn—O alloy, Sn, SnO, SnO₂, lithium titanate with a spinel structure (TiO₂—Li₄Ti₅O₁₂), or Li—Al alloy.

In some embodiments, the negative electrode material layer may further include a conductive agent, a binder, and a thickener. This application imposes no specific limitation on the types of conductive agent, binder, and thickener, as long as the purpose of this application can be achieved. For example, the conductive agent and binder may be at least one of the conductive agents or binders mentioned above, and the thickener may include, but is not limited to, at least one of sodium carboxymethyl cellulose or lithium carboxymethyl cellulose. This application imposes no specific limitation on the mass ratio of the negative electrode active material, conductive agent, binder, and thickener in the negative electrode material layer, and those skilled in the art may select according to actual needs, as long as the purpose of this application can be achieved.

This application imposes no specific limitation on the thickness of the negative electrode material layer, as long as the purpose of this application can be achieved. For example, the thickness of the negative electrode material layer may be 30 μm to 150 μm. This application imposes no specific limitation on the thickness of the negative electrode current collector, as long as the purpose of this application can be achieved. For example, the thickness of the negative electrode current collector may be 6 μm to 12 μm. This application imposes no specific limitation on the thickness of the negative electrode plate, as long as the purpose of this application can be achieved. For example, the thickness of the negative electrode plate may be 50 μm to 250 μm.

The separator in the electrochemical device is configured to separate the positive electrode plate and the negative electrode plate, preventing internal short circuits in the electrochemical device, allowing electrolyte ions to pass freely, and not affecting the electrochemical charge-discharge process. This application imposes no specific limitation on the separator, as long as the purpose of this application can be achieved. For example, the material of the separator may include, but is not limited to, at least one of polyolefin (PO)-based materials mainly including polyethylene (PE) or polypropylene (PP), polyester (for example, polyethylene terephthalate (PET) film), cellulose, polyimide (PI), polyamide (PA), spandex, or aramid. Exemplarily, polyethylene includes at least one of high-density polyethylene, low-density polyethylene, or ultra-high molecular weight polyethylene. The type of separator may include at least one of woven membranes, non-woven membranes, microporous membranes, composite membranes, rolled membranes, or spun membranes.

In some embodiments, the separator may include a substrate layer and a surface treatment layer. The substrate layer may be a non-woven fabric, membrane, or composite membrane with a porous structure, and the material of the substrate layer may include at least one of polyethylene, polypropylene, polyethylene terephthalate, or polyimide. Optionally, a polypropylene porous membrane, polyethylene porous membrane, polypropylene non-woven fabric, polyethylene non-woven fabric, or polypropylene-polyethylene-polypropylene porous composite membrane may be used. Optionally, a surface treatment layer is disposed on at least one surface of the substrate layer, and the surface treatment layer may be a polymer layer or an inorganic layer, or a layer formed by mixing a polymer and an inorganic material. For example, the inorganic layer includes inorganic particles and a binder, and the inorganic particles are not particularly limited, for example, the inorganic particles may include at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is not particularly limited, for example, the binder may be at least one of the binders mentioned above. The polymer layer includes a polymer, and the material of the polymer includes at least one of polyamide, polyacrylonitrile, acrylate polymer, polyacrylic acid, polyacrylate, polyvinylpyrrolidone, polyvinyl ether, polyvinylidene fluoride, or poly(vinylidene fluoride-hexafluoropropylene).

The preparation process of the electrochemical device of this application is well known to those skilled in the art, and this application imposes no specific limitation. For example, it may include, but is not limited to, the following steps: stacking the positive electrode plate, separator, and negative electrode plate in sequence, and performing operations such as winding or folding as needed to obtain an electrode assembly with a wound structure, placing the electrode assembly into a packaging bag, injecting the electrolyte into the packaging bag, and sealing to obtain the electrochemical device. Alternatively, the positive electrode plate, separator, and negative electrode plate are stacked in sequence, and the four corners of the entire stacked structure are fixed with tape to obtain an electrode assembly with a stacked structure. The electrode assembly is placed into a packaging bag, followed by electrolyte injection and sealing to obtain the electrochemical device. Additionally, overcurrent protection elements, guide plates, and the like may be placed in the packaging bag as needed to prevent pressure build-up and overcharge-discharge inside the electrochemical device. The packaging bag is a packaging bag known in the art, and this application imposes no limitation on it.

In some embodiments, the electrochemical device may include an electrode assembly. In some embodiments, the electrode assembly is a wound electrode assembly or a stacked electrode assembly. In some embodiments, the electrochemical device of this application includes, but is not limited to, all types of primary batteries, secondary batteries, or capacitors. In some embodiments, the electrochemical device is a lithium secondary battery. In some embodiments, the lithium secondary battery includes, but is not limited to, lithium metal secondary batteries, lithium-ion secondary batteries, lithium polymer secondary batteries, or lithium-ion polymer secondary batteries. In some embodiments, the electrochemical device is a sodium-ion battery.

This application further provides an electronic device including the electrochemical device described in this application.

This application imposes no specific limitation on the type of electronic device, which may be any electronic device known in the prior art. In some embodiments of this application, the electronic device may include, but is not limited to, notebook computers, pen-input computers, mobile computers, e-book readers, portable phones, portable fax machines, portable copiers, portable printers, head-mounted stereo headphones, video recorders, LCD TVs, portable cleaners, portable camcorders, mini-disc players, transceivers, electronic organizers, calculators, memory cards, portable recorders, radios, backup power supplies, motors, automobiles, motorcycles, assisted bicycles, bicycles, lighting fixtures, toys, gaming consoles, clocks, power tools, flashlights, cameras, large household batteries, and lithium-ion capacitors.

The preparation of lithium-ion batteries is described below as an example, in conjunction with the specific examples provided herein. Those skilled in the art will understand that the preparation methods described in this application are merely examples, and any other suitable preparation methods are within the scope of this application.

### Examples

The following describes the performance evaluation of lithium-ion cells according to the examples and comparative examples of this application.

### I. Preparation of Lithium-Ion Cells

### 1. Preparation of the Positive Electrode

The positive electrode active material lithium cobalt oxide (LiCoO₂), conductive agent carbon nanotubes (CNT), and binder polyvinylidene fluoride were mixed in a mass ratio of 95:2:3, and N-methylpyrrolidone (NMP) was added as a solvent. The mixture was stirred using a vacuum mixer to uniformity to obtain a positive electrode slurry with a solid content of 75 wt %. The positive electrode slurry was uniformly coated on one surface of a 12 μm thick aluminum foil positive electrode current collector, followed by drying at 85 °C and cold pressing to obtain a positive electrode plate with a positive electrode material layer thickness of 100 μm. The above steps were repeated on another surface of the aluminum foil to obtain a positive electrode plate coated with the positive electrode material layer on both sides. The positive electrode plate was cut to a size of 74 mm×867 mm and welded with tabs for use.

### 2. Preparation of the Negative Electrode

The negative electrode active material artificial graphite, styrene-butadiene rubber (SBR), and carboxymethyl cellulose (CMC) were mixed in a mass ratio of 95:2:3, and deionized water was added as a solvent to prepare a slurry with a solid content of 70 wt %, which was stirred to uniformity. The slurry was uniformly coated on one surface of an 8 μm thick copper foil, followed by drying at 110 °C and cold pressing, to obtain a negative electrode plate with a single-sided coated negative electrode material layer having a thickness of 150 μm. The above steps were repeated on another surface of the copper foil to obtain a negative electrode plate coated with the negative electrode material layer on both sides. The negative electrode plate was cut to a size of 75 mm×867 mm and welded with tabs for use.

### 3. Preparation of the Separator

A 15 mm thick polyethylene porous polymer film (manufacturer: Celgard, USA) was used as the separator.

### 4. Preparation of the Electrolyte

In an argon atmosphere glove box with a water content of less than 10 ppm, the components were mixed to uniformity with 0.3% LiBOB and 12.5% lithium hexafluorophosphate (LiPF₆) according to the settings of the following examples and comparative examples to obtain the electrolyte.

### 5. Preparation of Lithium-Ion Cells

The positive electrode plate, separator, and negative electrode plate were stacked in sequence, with the separator placed between the positive and negative electrode plates to provide isolation, and wound to obtain an electrode assembly. The electrode assembly was placed in an aluminum-plastic film packaging bag, moisture was removed at 80 °C, the prepared electrolyte was injected, and the bag was vacuum-sealed, followed by processes such as standing, formation, and shaping to obtain the lithium-ion cell. The formation upper limit voltage was 4.15 V, the formation temperature was 70 °C, and the formation standing time was 2 hours.

### II. Test Methods

### 1. Test Method for Discharge Specific Capacity of Lithium-Ion Cells

Preparation of lithium-ion coin cells: In a glove box, the negative electrode shell, gasket, lithium metal foil, separator, positive electrode plate, spring, and positive electrode shell were assembled in sequence, and the cell was encapsulated using an encapsulating machine. After placing each of the gasket, lithium metal foil, separator, and positive electrode plate, electrolyte was added to wet the same. The positive electrode plate, separator, and electrolyte used were the positive electrode plate, separator, and electrolyte from the respective examples or comparative examples. The diameter of the positive electrode plate was 14 mm, the diameter of the lithium metal foil was 16 mm, and the diameter of the separator was 16.5 mm.

At 25 °C, the prepared lithium-ion coin cells were charged at a 0.2 C rate until the voltage reached 4.5 V, further charged at a constant voltage of 4.5 V until the current was below 0.05 C, reaching a fully charged state at 4.5 V, and then discharged at a constant current of 0.2 C until the voltage was 3.0 V. The discharge capacity of the lithium-ion cells was tested: Discharge specific capacity of the lithium-ion cell=Discharge capacity/Mass of the positive electrode active material. The mass of the positive electrode active material was calculated based on the size of the positive electrode plate and the formulation used in the preparation of the positive electrode plate in each example or comparative example.

### 2. Test Method for High-Temperature Cycle Performance of Lithium-Ion Cells

At 45 °C, the lithium-ion cell was charged at a constant current of 0.7 C to 4.52 V, then charged at a constant voltage of 4.52 V until the current was 0.05 C, and discharged at a constant current of 1 C to 3.0 V. This was one charge-discharge cycle, and the discharge capacity of the lithium-ion cell of first cycle was recorded. The lithium-ion cell was cycled 500 times according to the above method, and the discharge capacity of the 500th cycle was recorded. The discharge capacity retention rate of the lithium-ion cell was calculated using the following formula:

Discharge capacity retention rate=Discharge capacity of the 500th cycle/Discharge capacity of the 1st cycle×100%.

The high-temperature cycle performance of the lithium-ion cell was evaluated by the discharge capacity retention rate. A higher discharge capacity retention rate indicates better high-temperature cycle performance, while a lower discharge capacity retention rate indicates poorer high-temperature cycle performance.

### 3. Test Method for Rate Performance of Lithium-Ion Cells

The lithium-ion cell was charged at a constant current of 0.7 C to 4.52 V, then charged at a constant voltage until the current was 0.05 C. After standing for 10 minutes, it was discharged at a constant current of 0.5 C to 3 V, and the discharge capacity DO was recorded. After standing for 15 minutes, the lithium-ion cell was again charged at a constant current of 0.7 C to 4.52 V, then charged at a constant voltage until the current was 0.05 C. After standing for 10 minutes, it was discharged at a constant current of 2 C to 3 V, and the discharge capacity D1 was recorded. The 2 C rate of the lithium-ion cell was calculated using the following formula:

2 C rate=D1/D0×100%.

### 4. Test Method for High-Temperature Storage Performance of Lithium-Ion Cells

At 25 °C, the thickness of the lithium-ion cell in a half-charged state was measured and recorded as C1. The lithium-ion cell was then charged at a constant current of 0.7 C to 4.5 V, followed by constant voltage charging until the current was 0.05 C, and left to stand for 10 minutes. The fully charged cell was stored at 85 °C for 8 hours, and the thickness was measured at 25 °C and recorded as C2. The high-temperature storage thickness expansion rate of the lithium-ion cell was calculated using the following formula:

High-temperature storage thickness expansion rate=(C2/C1−1)×100%.

### 5. Hot-Box Test Method for Lithium-Ion Cells

The lithium-ion cell was discharged at a constant current of 0.5 C to 3.0 V at 25 °C, then charged at a constant current of 0.5 C to 4.5 V, and charged at a constant voltage of 4.5 V until the current was 0.05 C. The cell was placed in a 132 °C high-temperature furnace for 1 hour, and after the test, it was observed whether the cell caught fire. A cell that did not catch fire was deemed to have passed. Ten samples were tested for each example, and the pass rate for the hot-box test was calculated.

### II. Test Results

Table 1 shows the effects of the first compound, the second compound, and their respective contents in the electrolyte on the specific capacity, rate performance, and high-temperature cycle performance of lithium-ion cells under high voltage.

TABLE 1

| | | | Formula (IV) | | | | | | Discharge |
|---|---|---|---|---|---|---|---|---|---|
| | First compound | | compound | | Second compound | | Specific | 2 C | capacity |
| | | Percentage | | Percentage | | Percentage | capacity | rate | retention |
| | Compound | (wt %) | Compound | (wt %) | Compound | B (wt %) | (mAh/g) | (%) | rate (%) |
| Example 1-1 | III-2 | 79 | IV-1 | 4 | EC | 4.2 | 175.8 | 65.5 | 84.8 |
| Example 1-2 | III-2 | 74.9 | IV-1 | 4 | EC | 8.3 | 175.9 | 69.9 | 85.8 |
| Example 1-3 | III-2 | 66.6 | IV-1 | 4 | EC | 16.6 | 175.9 | 73.8 | 86.7 |
| Example 1-4 | III-2 | 58.2 | IV-1 | 4 | EC | 25 | 175.8 | 75.5 | 87.1 |
| Example 1-5 | III-2 | 54.1 | IV-1 | 4 | EC | 29.1 | 175.7 | 73.5 | 86.2 |
| Example 1-6 | III-2 | 49.9 | IV-1 | 4 | EC | 33.3 | 175.5 | 70.3 | 85.4 |
| Example 1-7 | III-2 | 45.8 | IV-1 | 4 | EC | 37.4 | 175.5 | 67.7 | 80.1 |
| Example 1-8 | III-2 | 41.6 | IV-1 | 4 | EC | 41.6 | 175.2 | 65.6 | 72.4 |
| Example 1-9 | I-2 | 58.2 | IV-1 | 4 | EC | 25 | 175.3 | 73.7 | 86.8 |
| Example 1-10 | I-3 | 58.2 | IV-1 | 4 | EC | 25 | 175.6 | 75.2 | 84.6 |
| Example 1-11 | II-5 | 58.2 | IV-1 | 4 | EC | 25 | 175.4 | 76.8 | 85.3 |
| Example 1-12 | II-8 | 58.2 | IV-1 | 4 | EC | 25 | 175.5 | 77.4 | 87.5 |
| Example 1-13 | III-3 | 58.2 | IV-1 | 4 | EC | 25 | 175.9 | 75.6 | 86.2 |
| Example 1-14 | III-2 | 58.2 | IV-1 | 4 | PC | 25 | 175.7 | 73.3 | 87.8 |
| Example 1-15 | III-4 | 58.2 | IV-1 | 4 | EMC | 25 | 175.9 | 76.9 | 86.3 |
| Example 1-16 | III-2 | 58.2 | IV-1 | 4 | DEC | 25 | 175.8 | 75.4 | 86.5 |
| Example 1-17 | III-2 | 58.2 | IV-1 | 4 | EC + DEC | 10 + 15 | 175.6 | 77.9 | 87.1 |
| Example 1-18 | III-2 | 58.2 | IV-1 | 4 | PC + DEC | 10 + 15 | 175.7 | 77.2 | 88.2 |
| Example 1-19 | III-2 + I-4 | 20 + 38.2 | IV-1 | 4 | PC + DEC | 10 + 15 | 175.6 | 77.5 | 88 |
| Example 1-20 | III-2 + II-8 | 20 + 38.2 | IV-1 | 4 | PC + DEC | 10 + 15 | 175.8 | 77.3 | 88.5 |
| Example 1-21 | III-2 + II-8 | 16 + 38.2 | IV-1 | 8 | PC + DEC | 10 + 15 | 175.9 | 77.5 | 88.7 |
| Example 1-22 | III-2 + II-8 | 12 + 38.2 | IV-1 | 12 | PC + DEC | 10 + 15 | 175.8 | 78.1 | 89.5 |
| Example 1-23 | III-2 + II-8 | 9 + 38.2 | IV-1 | 15 | PC + DEC | 10 + 15 | 175.8 | 77.8 | 89.3 |
| Comparative | / | / | IV-1 | 4 | EC + DEC | 25 + 58.2 | 175.1 | 65.2 | 60.3 |
| Example 1 | | | | | | | | | |
| Comparative | III-2 | 83.2 | IV-1 | 4 | / | / | 175.6 | 64.7 | 71.5 |
| Example 2 | | | | | | | | | |
| Comparative | III-2 | 83.2 | 1 | / | EC + DEC | 4 | 175.3 | 63.7 | 70.5 |
| Example 3 | | | | | | | | | |

Note:
“EC” denotes ethylene carbonate, “PC” denotes propylene carbonate, “DEC” denotes diethyl carbonate, “EMC” denotes ethyl methyl carbonate, and “IV-1” denotes fluoroethylene carbonate.
“/” indicates not added or not present.

As shown in the comparative examples, when the electrolyte contains only two of the compound of formula (IV), the first compound, and the second compound, the specific capacity, rate performance, and high-temperature cycle performance of the lithium-ion cell under high voltage are poor. When the electrolyte contains an excessively high content of the second compound, the specific capacity, rate performance, and high-temperature cycle performance of the lithium-ion cell under high voltage are also poor.

As shown in the examples, when the electrolyte contains 41.6% to 79% by mass of the first compound, 4.2% to 41.6% by mass of the second compound, and 4% to 15% by mass of the compound of formula (IV), the specific capacity, 2 C rate, and discharge capacity retention rate of the lithium-ion cell can be significantly improved, thereby significantly enhancing the specific capacity, rate performance, and high-temperature cycle performance of the lithium-ion cell under high voltage. The improvement is particularly notable when the content of the first compound in the electrolyte is 45.8% to 74.9%, especially 49.9% to 74.9%, and the content of the second compound is 8.3% to 37.4%, especially 8.3% to 33.3%.

Table 2 shows the effects of nitrile compounds and their respective contents in the electrolyte on the cycle performance and high-temperature storage performance of lithium-ion cells under high temperature and high voltage. Except for the parameters listed in Table 2, other parameters of Examples 2-1 to 2-16 are consistent with those of Example 1-4. The added amounts of substances newly introduced in Table 2 compared to Example 1-4 are obtained by reducing the content of the second compound in Example 1-4 by the corresponding mass percentage, ensuring that the total content of all substances in the electrolyte sums to 100%.

TABLE 2

| | | | | | | | | High- |
|---|---|---|---|---|---|---|---|---|
| | | | | | Total | | | temperature |
| | | | | | nitrile | | Discharge | storage |
| | Dinitrile (wt %) | | Trinitrile (wt %) | | compound | | capacity | thickness |
| | | Percentage | | Percentage | percentage | 100 | retention | expansion |
| Example | Compound | (wt %) | Compound | (wt %) | C (wt %) | C/A | rate (%) | rate (%) |
| Example 1-4 | / | / | / | / | / | / | 87.1 | 25.2 |
| Example 2-1 | Succinonitrile | 0.1 | / | / | 0.1 | 0.2 | 87.3 | 25 |
| Example 2-2 | Succinonitrile | 2 | / | / | 2 | 3.4 | 88.2 | 12.4 |
| Example 2-3 | Succinonitrile | 3 | / | / | 3 | 5.2 | 89.3 | 8.3 |
| Example 2-4 | Succinonitrile | 7 | / | / | 7 | 12.0 | 87.2 | 7.8 |
| Example 2-5 | Adiponitrile | 2 | / | / | 2 | 3.4 | 88.4 | 13.5 |
| Example 2-6 | Suberonitrile | 2 | / | / | 2 | 3.4 | 88.5 | 12.7 |
| Example 2-7 | / | / | 1,3,6- | 0.1 | 0.1 | 0.2 | 87.4 | 24.9 |
| | | | Hexanetrinitrile | | | | | |
| Example 2-8 | / | / | 1,3,6- | 2 | 2 | 3.4 | 88.7 | 10.3 |
| | | | Hexanetrinitrile | | | | | |
| Example 2-9 | / | / | 1,3,6- | 3 | 3 | 5.2 | 89.8 | 7.1 |
| | | | Hexanetrinitrile | | | | | |
| Example 2-10 | / | / | 1,3,6- | 7 | 7 | 12.0 | 87.2 | 6.9 |
| | | | Hexanetrinitrile | | | | | |
| Example 2-11 | / | / | V-1 | 2 | 2 | 3.4 | 88.6 | 12.5 |
| Example 2-12 | / | / | V-11 | 2 | 2 | 3.4 | 88.9 | 12.1 |
| Example 2-13 | / | / | V-13 | 2 | 2 | 3.4 | 88.1 | 13.5 |
| Example 2-14 | Succinonitrile | 0.5 | 1,3,6- | 0.5 | 1 | 1.7 | 88.1 | 20.1 |
| | | | Hexanetrinitrile | | | | | |
| Example 2-15 | Succinonitrile | 1 | 1,3,6- | 1 | 2 | 3.4 | 89.1 | 8.2 |
| | | | Hexanetrinitrile | | | | | |
| Example 2-16 | Succinonitrile | 3 | 1,3,6- | 3 | 6 | 10.3 | 90.2 | 6.5 |
| | | | Hexanetrinitrile | | | | | |

Note:
“/” indicates not added or not present.

The results show that adding a nitrile compound with a mass percentage C (wt %) satisfying 0<C≤7 and 0<100C/A≤12.0 to an electrolyte containing 41.6% to 79% by mass of the first compound, 4.2% to 41.6% by mass of the second compound, and 4% to 15% by mass of the compound of formula (IV) can further improve the discharge capacity retention rate of the lithium-ion cell and significantly reduce the high-temperature storage thickness expansion rate of the lithium-ion cell.

Table 3 shows the effects of the compound of formula VI and its content in the electrolyte on the cycle performance and safety of lithium-ion cells under high temperature and high voltage. Except for the parameters listed in Table 3, other parameters of Examples 3-1 to 3-6 are consistent with those of Example 2-16. The added amounts of substances newly introduced in Table 3 compared to Example 2-16 are obtained by reducing the content of the second compound in Example 2-16 by the corresponding mass percentage, ensuring that the total content of all substances in the electrolyte sums to 100%.

TABLE 3

| | | | Discharge | |
|---|---|---|---|---|
| | Formula VI compound | | capacity | |
| | Com- | Percentage D | retention | Hot-box test |
| Example | pound | (wt %) | rate (%) | pass rate |
| Example 2-16 | / | / | 90.2 | 80% |
| Example 3-1 | VI-1 | 0.5 | 92.4 | 100% |
| Example 3-2 | VI-1 | 1 | 91.8 | 100% |
| Example 3-3 | VI-1 | 2 | 91.5 | 100% |
| Example 3-4 | VI-1 | 3 | 90.5 | 100% |
| Example 3-5 | VI-2 | 0.5 | 92.8 | 100% |
| Example 3-6 | VI-4 | 0.5 | 93.2 | 100% |

Note:
“/” indicates not added or not present.

The results show that adding 0.01% to 3% by mass of the compound of formula VI to an electrolyte containing 41.6% to 79% by mass of the first compound, 4.2% to 41.6% by mass of the second compound, 4% to 15% by mass of the compound of formula (IV), and no more than 7% by mass of the nitrile compound can further improve the discharge capacity retention rate of the lithium-ion cell and significantly increase its hot-box test pass rate, that is, improve its safety.

Table 4 shows the effects of the third compound and its content, as well as the first additive and its content, in the electrolyte on the cycle performance of lithium-ion cells under high temperature and high voltage. Except for the parameters listed in Table 4, other parameters of Examples 4-1 to 4-8 are consistent with those of Example 1-4. The added amounts of substances newly introduced in Table 4 compared to Example 1-4 are obtained by reducing the content of the second compound in Example 1-4 by the corresponding mass percentage, ensuring that the total content of all substances in the electrolyte sums to 100%.

TABLE 4

| | | | | | Discharge |
|---|---|---|---|---|---|
| | Third compound | | First additive | | capacity |
| | Com- | Percentage | Com- | Percentage | retention |
| Example | pound | (wt %) | pound | (wt %) | rate (%) |
| Example 1-4 | / | / | / | / | 87.1 |
| Example 4-1 | PP | 10 | / | / | 91.2 |
| Example 4-2 | PP | 20 | / | / | 91.5 |
| Example 4-3 | EP | 10 | / | / | 90.6 |
| Example 4-4 | EP | 20 | / | / | 90.8 |
| Example 4-5 | / | / | VC | 0.5 | 91.9 |
| Example 4-6 | / | / | VC + DTD | 0.5 + 1 | 92.5 |
| Example 4-7 | / | / | VC + | 0.5 + | 92.8 |
| | | | DTD + PS | 1 + 2 | |
| Example 4-8 | PP | 10 | VC + DTD | 0.5 + 1 | 93.4 |

Note:
“VC” denotes vinylene carbonate, “PS” denotes 1,3-propane sultone, and “DTD” denotes ethylene sulfate. “/” indicates not added or not present.

The results show that adding no more than 20% of the third compound and/or no more than 5% of the first additive to an electrolyte containing 41.6% to 79% by mass of the first compound, 4.2% to 41.6% by mass of the second compound, and 4% to 15% by mass of the compound of formula (IV) can further improve the discharge capacity retention rate of the lithium-ion cell.

Throughout the specification, references to “embodiment”, “some embodiments”, “one embodiment”, “another example”, “example”, “specific example”, or “some examples” mean that at least one embodiment or example in this application includes the specific feature, structure, material, or characteristic described in that embodiment or example. Therefore, descriptions appearing in various parts of the specification, such as “in some embodiments”, “in an embodiment”, “in one embodiment”, “in another example”, “in an example”, “in a specific example”, or “example”, do not necessarily refer to the same embodiment or example in this application. Furthermore, the specific features, structures, materials, or characteristics herein may be combined in any suitable manner in one or more embodiments or examples.

Although illustrative embodiments have been demonstrated and described, those skilled in the art should understand that the above embodiments are not to be construed as limiting the application, and changes, substitutions, and modifications may be made to the embodiments without departing from the spirit, principles, and scope of this application.

What is claimed is:

1. An electrolyte comprising a first compound, a second compound, and a compound of formula (IV); wherein
the first compound comprises at least one selected from the group consisting of a compound of formula (I), a compound of formula (II), and a compound of formula (III); wherein the structural formulas of the compounds of formula (I), formula (II), formula (III), and formula (IV) are as follows: 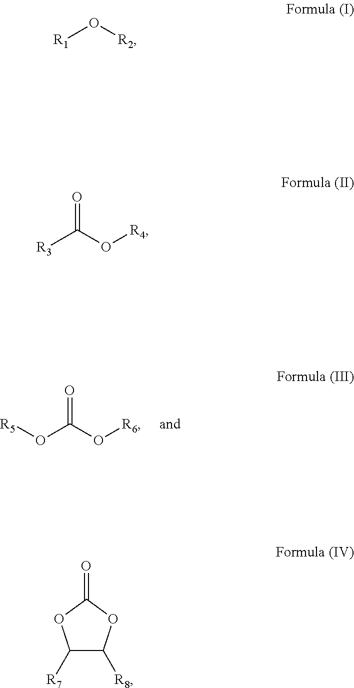
wherein R₁, R₂, R₃, R₄, R₅, R₆, R₇, and R₈ are each independently selected from the group consisting of H, F, C₁-C₅ alkyl, C₂-C₅ alkenyl, C₂-C₅ alkynyl, fluorine-substituted C₁-C₅ alkyl, fluorine-substituted C₂-C₅ alkenyl, fluorine-substituted C₂-C₅ alkynyl, sulfonic acid-substituted C₂-C₅ alkyl, and cyano-substituted C₂-C₅ alkyl;
at least one of R₁ or R₂ contains at least one fluorine atom; at least one of R₃ or R₄ contains at least one fluorine atom; at least one of R₅ or R₆ contains at least one fluorine atom; and at least one of R₇ or R₈ contains at least one fluorine atom;
the second compound comprises at least one selected from the group consisting of the following compounds: ethylene carbonate, propylene carbonate, butylene carbonate, dimethyl carbonate, ethyl methyl carbonate, diethyl carbonate, dipropyl carbonate, methyl propyl carbonate, ethyl propyl carbonate, dioctyl carbonate, dipentyl carbonate, ethyl isobutyl carbonate, methyl isopropyl carbonate, dibutyl carbonate, diisopropyl carbonate, and propyl carbonate; and
based on a mass of the electrolyte, a mass percentage of the first compound is A % and 41.6≤A≤79, a mass percentage of the second compound is B % and 4.2≤B≤41.6, and a mass percentage of the compound of formula (IV) is 4% to 15%.

2. The electrolyte according to claim 1, wherein the first compound comprises at least one selected from the group consisting of the following compounds: 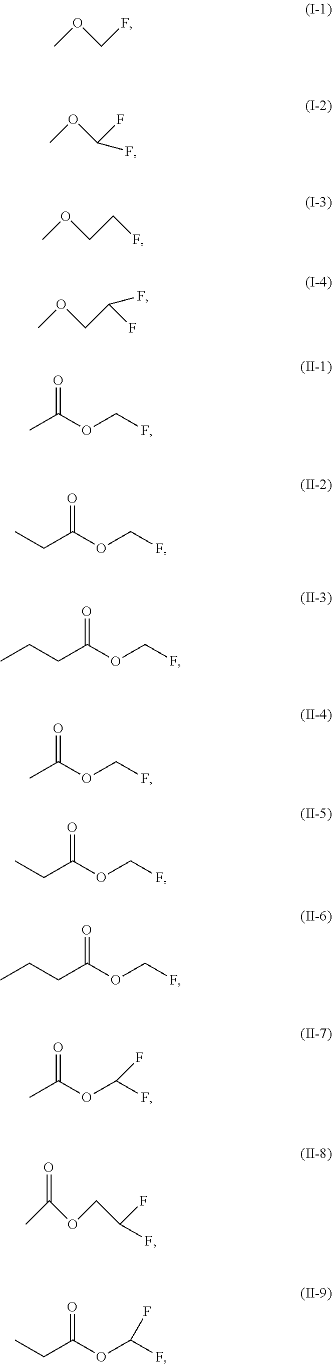 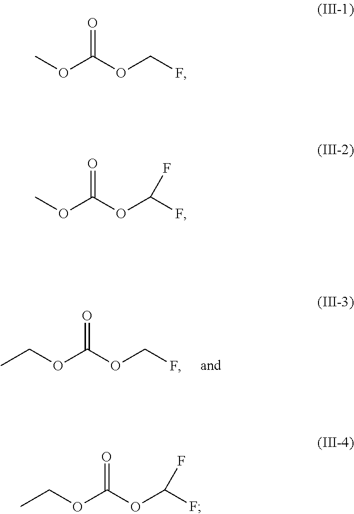
and
the compound of formula (IV) comprises at least one selected from the group consisting of the following compounds:

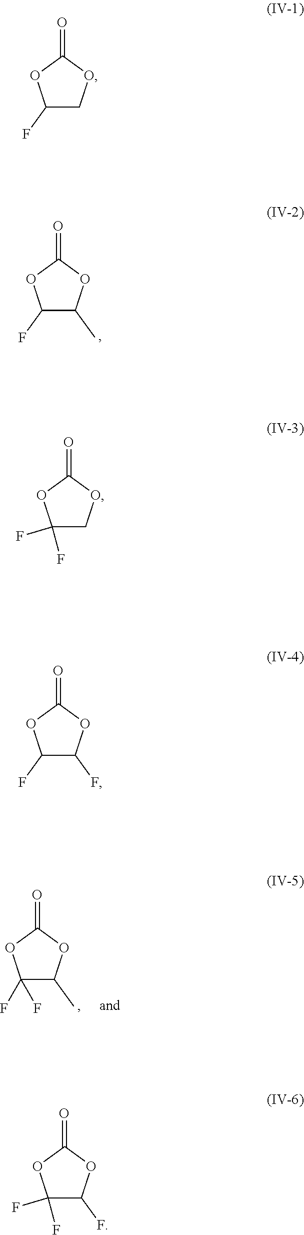

3. The electrolyte according to claim 1, wherein 45.8≤A≤74.9 and 8.3≤B≤37.4.

4. The electrolyte according to claim 1, wherein 49.9≤A≤74.9 and 8.3≤B≤33.3.

5. The electrolyte according to claim 1, wherein the electrolyte further comprises a nitrile compound; and based on the mass of the electrolyte, a mass percentage of the nitrile compound is C %, wherein 0<C≤7 and 0<100C/A≤12.0.

6. The electrolyte according to claim 5, wherein the nitrile compound comprises at least one selected from the group consisting of a compound having two cyano groups and a compound having three or more cyano groups; wherein,
the compound having two cyano groups comprises at least one selected from the group consisting of the following compounds: malononitrile, succinonitrile, glutaronitrile, adiponitrile, suberonitrile, terephthalonitrile, tetradecanedinitrile, azopropanedinitrile, methyleneglutaronitrile, and pentenedinitrile; and
the compound having three or more cyano groups comprises at least one selected from the group consisting of the following compounds: nonanetrinitrile, 1,3,5-benzenetrinitrile, 2,4,6-trifluorobenzene-1,3,5-trinitrile, 2-bromobenzene-1,3,5-trinitrile, 1,3,6-hexanetrinitrile, propane-1,2,3-tricarbonitrile, pentane-1,3,5-tricarbonitrile, hexane-1,2,6-tricarbonitrile, and a compound of formula (V); wherein the compound of formula (V) comprises at least one selected from the group consisting of the following compounds:

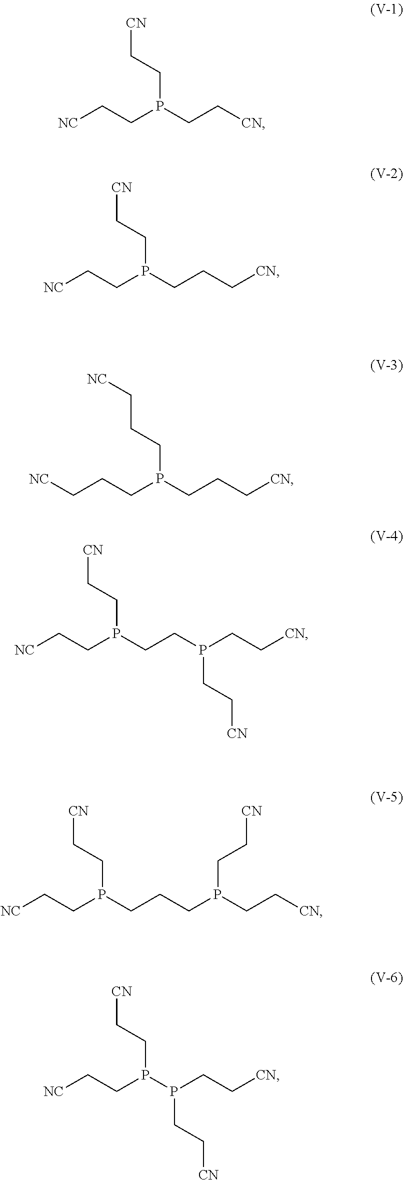 [SMILES: N#CCCP(CCC#N)CCC#N ; N#CCCCP(CCC#N)CCC#N ; N#CCCCP(CCCC#N)CCCC#N ; N#CCCP(CCC#N)CCP(CCC#N)CCC#N ; N#CCCP(CCC#N)CCCP(CCC#N)CCC#N ; N#CCCP(CCC#N)P(CCC#N)CCC#N]

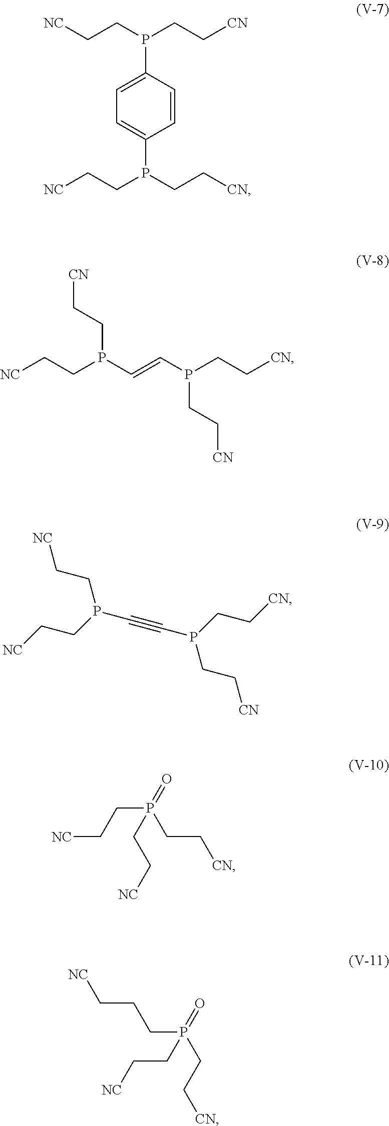 [SMILES: N#CCCP(CCC#N)c1ccc(P(CCC#N)CCC#N)cc1 ; N#CCCP(/C=C/P(CCC#N)CCC#N)CCC#N ; N#CCCP(C#CP(CCC#N)CCC#N)CCC#N ; N#CCCP(=O)(CCC#N)CCC#N ; N#CCCCP(=O)(CCC#N)CCC#N]

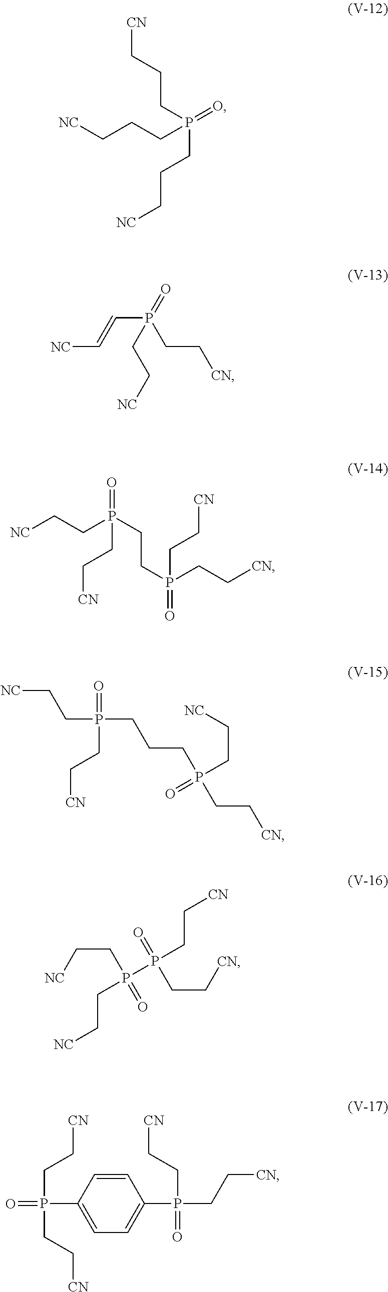 [SMILES: N#CCCCP(=O)(CCCC#N)CCCC#N ; N#C/C=C/P(=O)(CCC#N)CCC#N ; N#CCCP(=O)(CCC#N)CCP(=O)(CCC#N)CCC#N ; N#CCCP(=O)(CCC#N)CCCP(=O)(CCC#N)CCC#N ; N#CCCP(=O)(CCC#N)P(=O)(CCC#N)CCC#N ; N#CCCP(=O)(CCC#N)c1ccc(P(=O)(CCC#N)CCC#N)cc1]

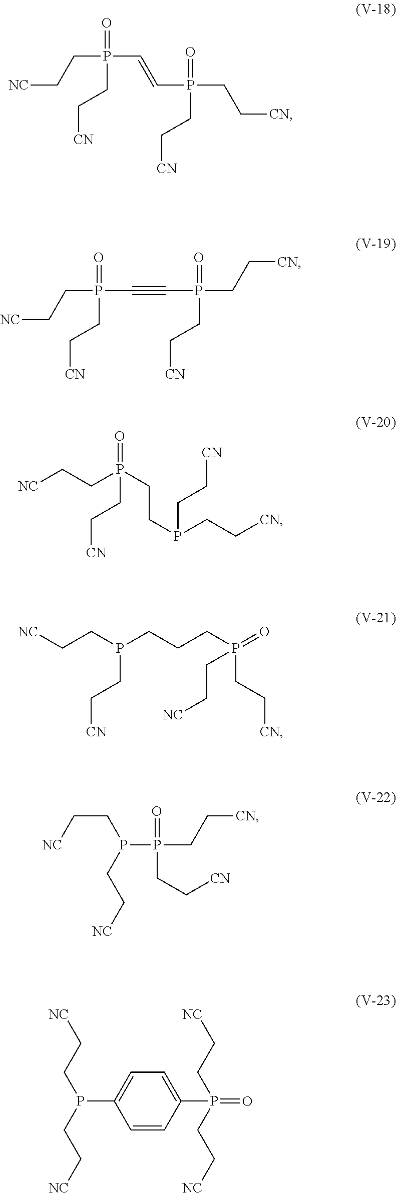 [SMILES: N#CCCP(=O)(/C=C/P(=O)(CCC#N)CCC#N)CCC#N ; N#CCCP(=O)(C#CP(=O)(CCC#N)CCC#N)CCC#N ; N#CCCP(CCC#N)CCP(=O)(CCC#N)CCC#N ; N#CCCP(CCC#N)CCCP(=O)(CCC#N)CCC#N ; N#CCCP(CCC#N)P(=O)(CCC#N)CCC#N ; N#CCCP(CCC#N)c1ccc(P(=O)(CCC#N)CCC#N)cc1]

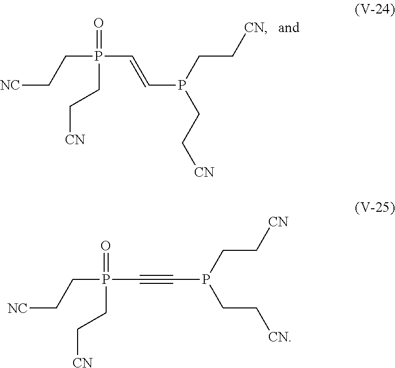 [SMILES: N#CCCP(/C=C/P(=O)(CCC#N)CCC#N)CCC#N ; "and" ; N#CCCP(C#CP(=O)(CCC#N)CCC#N)CCC#N]

7. The electrolyte according to claim 5, wherein the electrolyte further comprises a compound of formula (VI): 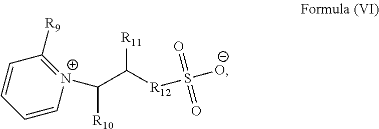
wherein R₉, R₁₀, and R₁₁ are each independently selected from the group consisting H, F, substituted or unsubstituted C₁-C₅ alkyl, C₁-C₅ alkoxy, C₂-C₅ alkenyl, and C₂-C₅ alkynyl; wherein when any of these groups is substituted, the substituent is at least one selected from the group consisting of F, formyl, and cyano;
R₁₂ is selected from the group consisting of O and —CH(Rₐ)—; and Rₐ is selected from the group consisting of H, F, substituted or unsubstituted C₁-C₅ alkyl, and C₁-C₅ alkoxy, wherein when any of these groups is substituted, the substituent is at least one selected from the group consisting of F, formyl, and cyano;
and based on the mass of the electrolyte, a mass percentage of the compound of formula (VI) is D % and D is in a range of 0.01 to 3.

8. The electrolyte according to claim 7, wherein the compound of formula (VI) comprises at least one selected from the group consisting of the following compounds:

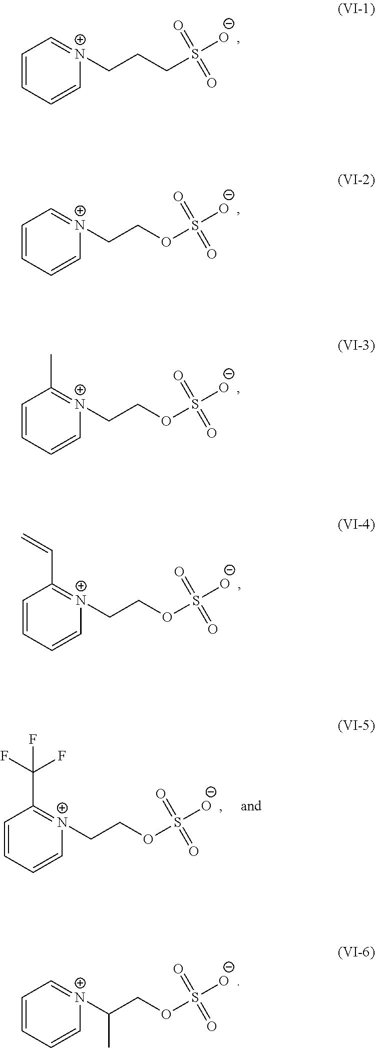 [SMILES: O=S(=O)([O-])CCC[n+]1ccccc1 ; O=S(=O)([O-])OCC[n+]1ccccc1 ; Cc1cccc[n+]1CCOS(=O)(=O)[O-] ; C=Cc1cccc[n+]1CCOS(=O)(=O)[O-] ; O=S(=O)([O-])OCC[n+]1ccccc1C(F)(F)F ; CC(COS(=O)(=O)[O-])[n+]1ccccc1]

9. The electrolyte according to claim 1, wherein the electrolyte further comprises a first additive; the first additive comprises at least one of 1,3-propane sultone, ethylene sulfate, or vinylene carbonate; and based on the mass of the electrolyte, a mass percentage of the first additive is less than or equal to 5%.

10. The electrolyte according to claim 1, wherein the electrolyte further comprises a third compound; the third compound comprising at least one of methyl acetate, ethyl acetate, propyl acetate, methyl propionate, ethyl propionate, propyl propionate, butyl propionate, methyl butyrate, ethyl butyrate, propyl butyrate, or butyl butyrate; and based on the mass of the electrolyte, a mass percentage of the third compound is less than or equal to 20%.

11. An electrochemical device comprising a positive electrode, a negative electrode, a separator, and an electrolyte; the electrolyte comprises a first compound, a second compound, and a compound of formula (IV); wherein,
the first compound comprises at least one selected from the group consisting of a compound of formula (I), a compound of formula (II), and a compound of formula (III); wherein the structural formulas of the compounds of formula (I), formula (II), formula (III), and formula (IV) are as follows: 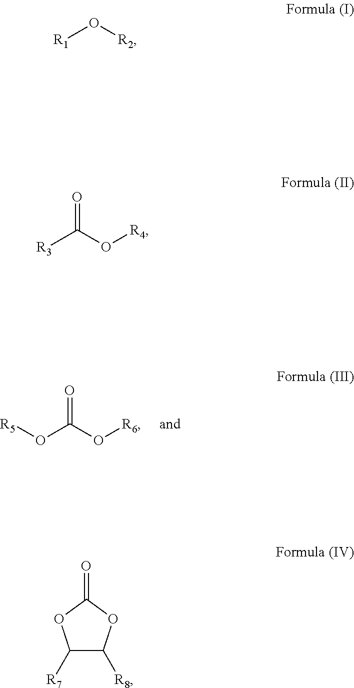
wherein R₁, R₂, R₃, R₄, R₅, R₆, R₇, and R₈ are each independently selected from the group consisting of H, F, C₁-C₅ alkyl, C₂-C₅ alkenyl, C₂-C₅ alkynyl, fluorine-substituted C₁-C₅ alkyl, fluorine-substituted C₂-C₅ alkenyl, fluorine-substituted C₂-C₅ alkynyl, sulfonic acid-substituted C₂-C₅ alkyl, and cyano-substituted C₂-C₅ alkyl;
at least one of R₁ or R₂ contains at least one fluorine atom; at least one of R₃ or R₄ contains at least one fluorine atom; at least one of R₅ or R₆ contains at least one fluorine atom; and at least one of R₇ or R₈ contains at least one fluorine atom;
the second compound comprises at least one selected from the group consisting of the following compounds: ethylene carbonate, propylene carbonate, butylene carbonate, dimethyl carbonate, ethyl methyl carbonate, diethyl carbonate, dipropyl carbonate, methyl propyl carbonate, ethyl propyl carbonate, dioctyl carbonate, dipentyl carbonate, ethyl isobutyl carbonate, methyl isopropyl carbonate, dibutyl carbonate, diisopropyl carbonate, and propyl carbonate; and
based on a mass of the electrolyte, a mass percentage of the first compound is A % and 41.6≤A≤79, a mass percentage of the second compound is B % and 4.2≤B≤41.6, and a mass percentage of the compound of formula (IV) is 4% to 15%.

12. The electrochemical device according to claim 11, wherein the first compound comprises at least one selected from the group consisting of the following compounds: 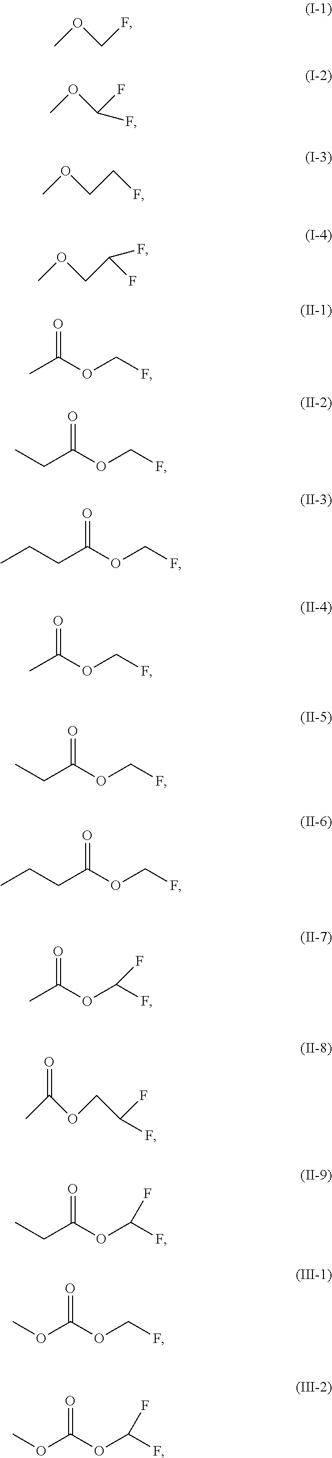 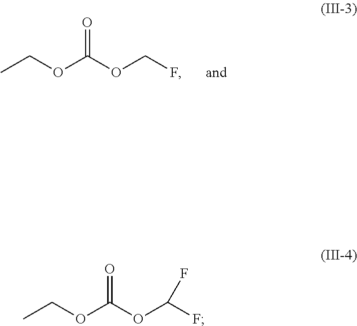
and
the compound of formula (IV) comprises at least one selected from the group consisting of the following compounds:

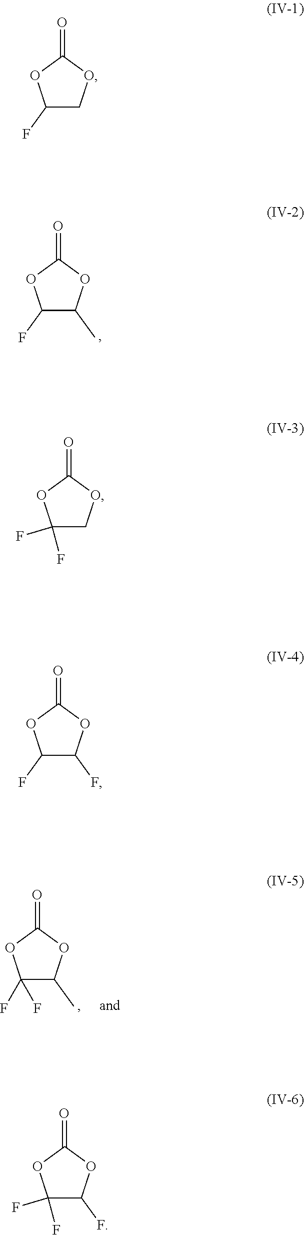

13. The electrochemical device according to claim 11, wherein 45.8≤A≤74.9 and 8.3≤B≤37.4.

14. The electrochemical device according to claim 11, wherein the electrolyte further comprises a nitrile compound; and based on the mass of the electrolyte, a mass percentage of the nitrile compound is C %, wherein 0<C≤7 and 0<100C/A≤12.0.

15. The electrochemical device according to claim 14, wherein the nitrile compound comprises at least one selected from the group consisting of a compound having two cyano groups and a compound having three or more cyano groups; wherein,
the compound having two cyano groups comprises at least one selected from the group consisting of the following compounds: malononitrile, succinonitrile, glutaronitrile, adiponitrile, suberonitrile, terephthalonitrile, tetradecanedinitrile, azopropanedinitrile, methyleneglutaronitrile, and pentenedinitrile; and
the compound having three or more cyano groups comprises at least one selected from the group consisting of the following compounds: nonanetrinitrile, 1,3,5-benzenetrinitrile, 2,4,6-trifluorobenzene-1,3,5-trinitrile, 2-bromobenzene-1,3,5-trinitrile, 1,3,6-hexanetrinitrile, propane-1,2,3-tricarbonitrile, pentane-1,3,5-tricarbonitrile, hexane-1,2,6-tricarbonitrile, and a compound of formula (V); wherein the compound of formula (V) comprises at least one selected from the group consisting of the following compounds:

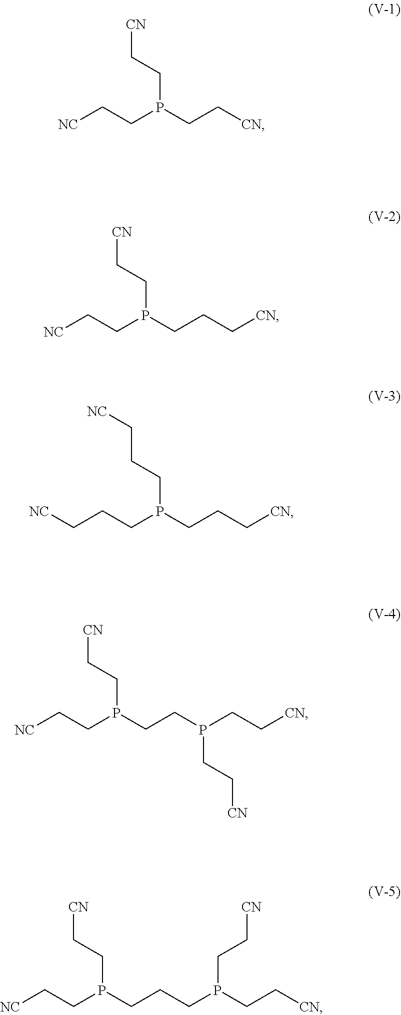

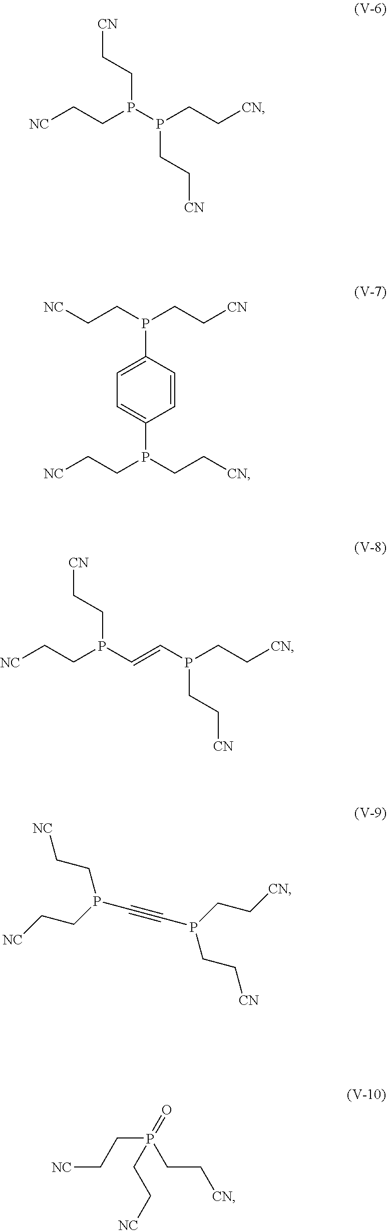

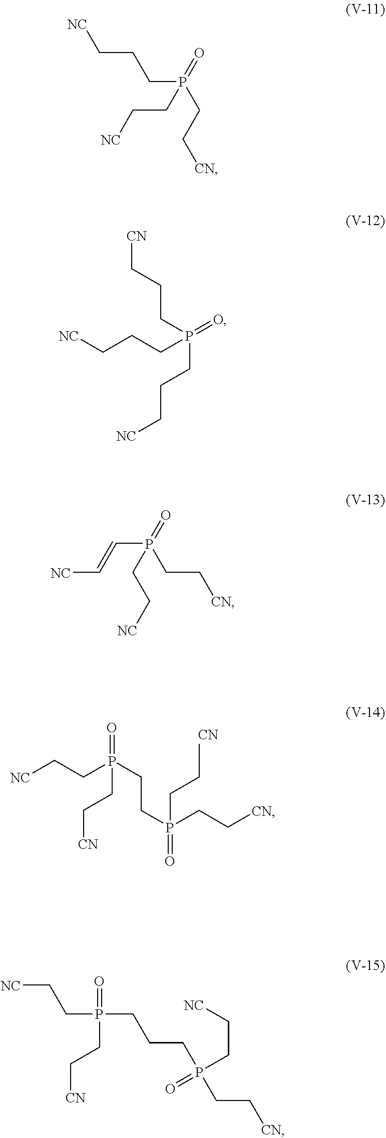

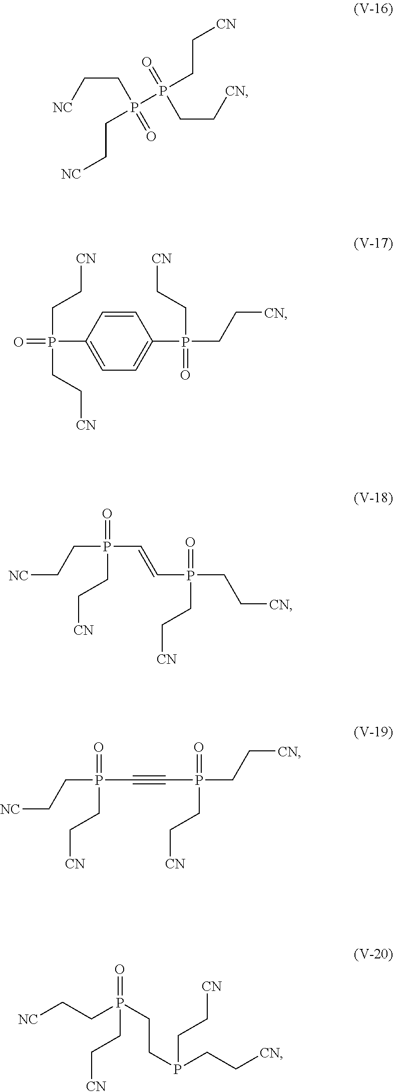

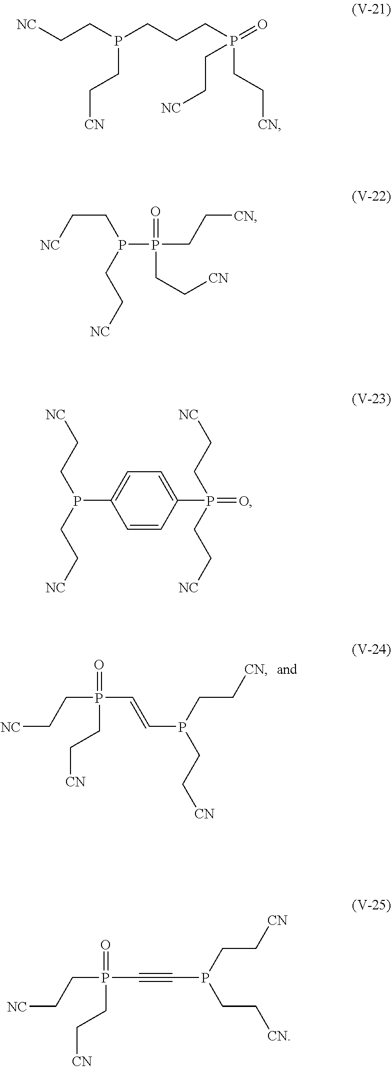

16. The electrochemical device according to claim 14, wherein the electrolyte further comprises a compound of formula (VI): 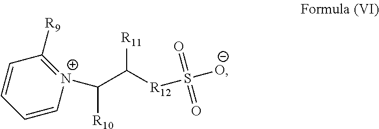
wherein R₉, R₁₀, and R₁₁ are each independently selected from the group consisting H, F, substituted or unsubstituted C₁-C₅ alkyl, C₁-C₅ alkoxy, C₂-C₅ alkenyl, and C₂-C₅ alkynyl; wherein when any of these groups is substituted, the substituent is at least one selected from the group consisting of F, formyl, and cyano;
R₁₂ is selected from the group consisting of O and —CH(R)—; and Rₐ is selected from the group consisting of H, F, substituted or unsubstituted C₁-C₅ alkyl, and C₁-C₅ alkoxy, wherein when any of these groups is substituted, the substituent is at least one selected from the group consisting of F, formyl, and cyano;
and based on the mass of the electrolyte, a mass percentage of the compound of formula (VI) is D % and D is in a range of 0.01 to 3.

17. The electrochemical device according to claim 16, wherein the compound of formula (VI) comprises at least one selected from the group consisting of the following compounds:

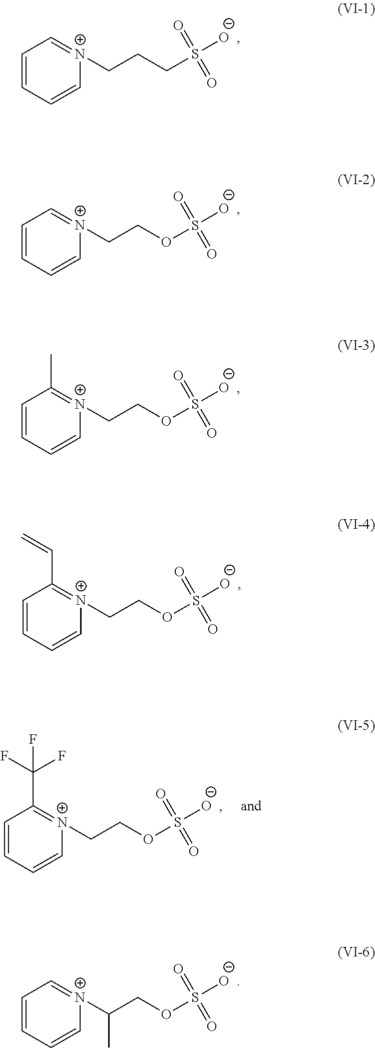 [SMILES: O=S(=O)([O-])CCC[n+]1ccccc1 ; O=S(=O)([O-])OCC[n+]1ccccc1 ; Cc1cccc[n+]1CCOS(=O)(=O)[O-] ; C=Cc1cccc[n+]1CCOS(=O)(=O)[O-] ; O=S(=O)([O-])OCC[n+]1ccccc1C(F)(F)F ; CC(COS(=O)(=O)[O-])[n+]1ccccc1]

18. The electrochemical device according to claim 11, wherein the electrolyte further comprises a first additive; the first additive comprises at least one of 1,3-propane sultone, ethylene sulfate, or vinylene carbonate; and based on the mass of the electrolyte, a mass percentage of the first additive is less than or equal to 5%.

19. The electrochemical device according to claim 11, wherein the electrolyte further comprises a third compound; the third compound comprising at least one of methyl acetate, ethyl acetate, propyl acetate, methyl propionate, ethyl propionate, propyl propionate, butyl propionate, methyl butyrate, ethyl butyrate, propyl butyrate, or butyl butyrate; and based on the mass of the electrolyte, a mass percentage of the third compound is less than or equal to 20%.

20. An electronic device comprising an electrochemical device, the electrochemical device comprises a positive electrode, a negative electrode, a separator, and an electrolyte; the electrolyte comprises a first compound, a second compound, and a compound of formula (IV); wherein,
the first compound comprises at least one selected from the group consisting of a compound of formula (I), a compound of formula (II), and a compound of formula (III); wherein the structural formulas of the compounds of formula (I), formula (II), formula (III), and formula (IV) are as follows: 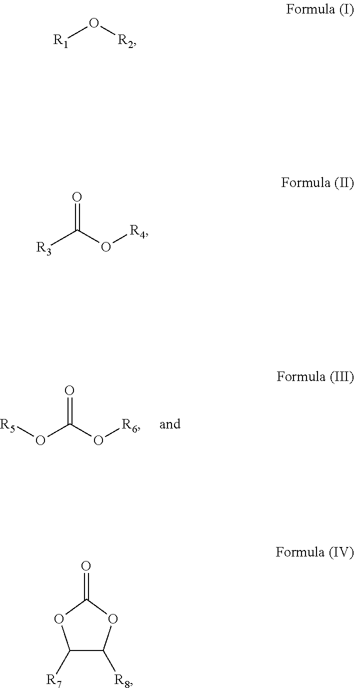
wherein R₁, R₂, R₃, R₄, R₅, R₆, R₇, and R₈ are each independently selected from the group consisting of H, F, C₁-C₅ alkyl, C₂-C₅ alkenyl, C₂-C₅ alkynyl, fluorine-substituted C₁-C₅ alkyl, fluorine-substituted C₂-C₅ alkenyl, fluorine-substituted C₂-C₅ alkynyl, sulfonic acid-substituted C₂-C₅ alkyl, and cyano-substituted C₂-C₅ alkyl;
at least one of R₁ or R₂ contains at least one fluorine atom; at least one of R₃ or R₄ contains at least one fluorine atom; at least one of R₅ or R₆ contains at least one fluorine atom; and at least one of R₇ or R₈ contains at least one fluorine atom;
the second compound comprises at least one selected from the group consisting of the following compounds: ethylene carbonate, propylene carbonate, butylene carbonate, dimethyl carbonate, ethyl methyl carbonate, diethyl carbonate, dipropyl carbonate, methyl propyl carbonate, ethyl propyl carbonate, dioctyl carbonate, dipentyl carbonate, ethyl isobutyl carbonate, methyl isopropyl carbonate, dibutyl carbonate, diisopropyl carbonate, and propyl carbonate; and
based on a mass of the electrolyte, a mass percentage of the first compound is A % and 41.6≤A≤79, a mass percentage of the second compound is B % and 4.2≤B≤41.6, and a mass percentage of the compound of formula (IV) is 4% to 15%.
